(19) United States
(12) Patent Application Publication
(10) Pub. No.: US 2025/0211736 A1
(43) Pub. Date: Jun. 26, 2025

(54) VIDEO DATA PROCESSING METHOD AND APPARATUS, COMPUTER DEVICE, AND STORAGE MEDIUM

(71) Applicant: Tencent Technology (Shenzhen) Company Limited, Shenzhen (CN)

(72) Inventor: Jia ZHANG, Shenzhen (CN)

(21) Appl. No.: 19/080,420

(22) Filed: Mar. 14, 2025

Related U.S. Application Data
(63) Continuation of application No. PCT/CN2023/140294, filed on Dec. 20, 2023.

(30) Foreign Application Priority Data
Feb. 17, 2023 (CN) 202310159839.9

(51) Int. Cl. H04N 19/105; H04N 19/119; H04N 19/172; H04N 19/192

(52) U.S. Cl. CPC H04N 19/105; H04N 19/119; H04N 19/172; H04N 19/192

(57) ABSTRACT

Embodiments of this application provide a video data processing method performed by a computer device, and the method includes: performing recursive hierarchical division on a target unit in a target video frame, to obtain S hierarchical division forms for the target unit, obtaining an optimal coding mode for the target unit from the S hierarchical division forms, and obtaining a hierarchical sub-coding unit corresponding to the optimal coding mode; and cropping, based on the hierarchical sub-coding unit, when a coding result of the hierarchical sub-coding unit satisfies a motion similarity condition, a full reference frame set constructed for the target unit, to generate a candidate reference frame set corresponding to the target unit in a non-division form, the candidate reference frame set being configured for obtaining a target reference frame for the target unit through traversal, and the target reference frame being configured for coding the target unit.

### CROSS-REFERENCE TO RELATED APPLICATIONS

This application is a continuation application of PCT Patent Application No. PCT/CN2023/140294, entitled “VIDEO DATA PROCESSING METHOD AND APPARATUS, COMPUTER DEVICE, AND STORAGE MEDIUM” filed on Dec. 20, 2023, which claims priority to Chinese Patent Application No. 202310159839.9, entitled “VIDEO DATA PROCESSING METHOD AND APPARATUS, COMPUTER DEVICE, AND STORAGE MEDIUM” filed with the China National Intellectual Property Administration on Feb. 17, 2023, all of which are incorporated by reference in their entirety.

### FIELD OF THE TECHNOLOGY

This application relates to the field of internet technologies, and in particular, to a video data processing method and apparatus, a computer device, and a storage medium.

### BACKGROUND OF THE DISCLOSURE

In a data transmission scenario (for example, a livestreaming scenario), to-be-transmitted video data needs to be coded, to obtain a video bitstream corresponding to the video data, so as to improve transmission efficiency. In a process of coding the video data, a to-be-coded unit of a to-be-coded target video frame needs to be obtained from the video data, to perform inter prediction or intra prediction on the to-be-coded unit. During the inter prediction, for an inter prediction mode, a reference frame for coding the to-be-coded unit needs to be determined in the video data by using a reference frame selection algorithm.

In a current reference frame selection algorithm, a video frame coded before the target video frame may be obtained. In a reference frame selection algorithm, distances between these video frames and the target video frame and coding quality of the video frames may be determined, the distances and the coding quality are further superimposed, superimposed results are sorted from largest to smallest, and a video frame corresponding to a largest value selected from the sorted results is used as a target reference frame corresponding to the to-be-coded unit in the target video frame. However, in the reference frame selection algorithm, only a distance between the target reference frame and the target video frame and coding quality of the target reference frame are considered, but content similarity between the target reference frame and the target video frame is not considered. When image content of the target reference frame changes sharply compared with the target video frame, content in the target reference frame is quite different from that in the target video frame, and coding the target video frame based on the target reference frame having a large content difference significantly reduces a coding effect of the target video frame. In another reference frame selection algorithm, these video frames may be traversed to code each possible reference frame combination, to find an optimal reference frame. However, if a large quantity of video frames are coded before the target video frame, a large amount of time needs to be consumed in a process of traversing these video frames in the reference frame selection algorithm, reducing coding efficiency of the target video frame. As a result, the coding effect and the coding efficiency cannot both be ensured in the current reference frame selection algorithm.

### SUMMARY

Embodiments of this application provide a video data processing method and apparatus, a computer device, and a storage medium, so that a coding effect and coding efficiency of the target video frame can both be ensured.

According to one aspect of embodiments of this application, a video data processing method is performed by a computer device, the method including:
performing recursive hierarchical division on a target unit in a target video frame, to obtain S hierarchical division forms for the target unit, S being a positive integer, and the target video frame being a video frame in video data;
obtaining an optimal coding mode for the target unit from the S hierarchical division forms, and obtaining a hierarchical sub-coding unit corresponding to the optimal coding mode; and
cropping, based on the hierarchical sub-coding unit, if a coding result of the hierarchical sub-coding unit satisfies a motion similarity condition, a full reference frame set constructed for the target unit, to generate a candidate reference frame set corresponding to the target unit in a non-division form, the candidate reference frame set being configured for obtaining a target reference frame for the target unit through traversal, and the target reference frame being configured for coding the target unit.

According to one aspect of embodiments of this application provides a video data processing apparatus, including:
a division module, configured to perform recursive hierarchical division on a target unit in a target video frame, to obtain S hierarchical division forms for the target unit, S being a positive integer, and the target video frame being a video frame in video data;
an obtaining module, configured to: obtain an optimal coding mode for the target unit from the S hierarchical division forms, and obtain a hierarchical sub-coding unit corresponding to the optimal coding mode; and
a cropping module, configured to: crop, based on the hierarchical sub-coding unit, if a coding result of the hierarchical sub-coding unit satisfies a motion similarity condition, a full reference frame set constructed for the target unit, to generate a candidate reference frame set corresponding to the target unit in a non-division form, the candidate reference frame set being configured for obtaining a target reference frame for the target unit through traversal, and the target reference frame being configured for coding the target unit.

The division module includes:
a division unit, configured to perform unit division on the target unit in the target video frame, to obtain S unit division forms for the target unit, the S unit division forms including a target unit division form; the target unit division form including N division sub-coding units of the target unit; N being an integer greater than 1; and the N division sub-coding units including a target division sub-coding unit;
a mode obtaining unit, configured to obtain a final sub-unit coding mode corresponding to the target division sub-coding unit; and
a mode determining unit, configured to determine final sub-unit coding modes respectively corresponding to the N division sub-coding units as hierarchical division forms corresponding to the target unit in the target unit division form.

The mode obtaining unit is specifically configured to perform, if the target division sub-coding unit satisfies a unit division condition, recursive hierarchical division on the target division sub-coding unit, to obtain S sub-unit hierarchical division forms for the target division sub-coding unit.

The mode obtaining unit is specifically configured to: obtain an optimal sub-unit coding mode for the target division sub-coding unit from the S sub-unit hierarchical division forms, and obtain a sub-unit hierarchical sub-coding unit corresponding to the optimal sub-unit coding mode.

The mode obtaining unit is specifically configured to crop, based on the sub-unit hierarchical sub-coding unit, if a sub-unit coding result of the sub-unit hierarchical sub-coding unit satisfies the motion similarity condition, a sub-unit full reference frame set constructed for the target division sub-coding unit, to generate a sub-unit candidate reference frame set corresponding to the target division sub-coding unit in the non-division form. The sub-unit candidate reference frame set is configured for obtaining a sub-unit target reference frame for the target division sub-coding unit through traversal, and the sub-unit target reference frame is configured for coding the target division sub-coding unit.

The mode obtaining unit is specifically configured to obtain, from the optimal sub-unit coding mode and the non-division form, the final sub-unit coding mode corresponding to the target division sub-coding unit.

The mode obtaining unit is specifically configured to obtain a sub-unit size of the target division sub-coding unit.

The mode obtaining unit is specifically configured to determine, if the sub-unit size is greater than or equal to a size threshold, that the target division sub-coding unit satisfies the unit division condition; or
the mode obtaining unit is specifically configured to determine, if the sub-unit size is less than a size threshold, that the target division sub-coding unit does not satisfy the unit division condition.

The mode obtaining unit is specifically configured to determine, if the target division sub-coding unit does not satisfy the unit division condition, the non-division form as the final sub-unit coding mode corresponding to the target division sub-coding unit.

The optimal coding mode includes M division sub-coding units of the target unit; M is an integer greater than 1; and the M division sub-coding units includes an auxiliary division sub-coding unit.

The obtaining module includes:
a first determining unit, configured to determine, if the auxiliary division sub-coding unit has no sub-coding unit, the auxiliary division sub-coding unit as the hierarchical sub-coding unit corresponding to the optimal coding mode, and
a second determining unit, configured to obtain, if the auxiliary division sub-coding unit has sub-coding units, the hierarchical sub-coding unit corresponding to the optimal coding mode from the auxiliary division sub-coding unit.

The candidate reference frame set includes a forward candidate reference frame set and a backward candidate reference frame set. The full reference frame set includes a forward full reference frame set and a backward full reference frame set.

The cropping module includes:
a set obtaining unit, configured to obtain, from the video data, the forward full reference frame set and the backward full reference frame set that are constructed for the target unit;
a first selecting unit, configured to: select, in the forward full reference frame set, a reference frame used for the hierarchical sub-coding unit, and determine, if the reference frame used for the hierarchical sub-coding unit exists in the forward full reference frame set, the reference frame selected in the forward full reference frame set as the forward candidate reference frame set corresponding to the target unit in the non-division form; and
a second selecting unit, configured to: select, in the backward full reference frame set, a reference frame used for the hierarchical sub-coding unit, and determine, if the reference frame used for the hierarchical sub-coding unit exists in the backward full reference frame set, the reference frame selected in the backward full reference frame set as the backward candidate reference frame set corresponding to the target unit in the non-division form.

The set obtaining unit is specifically configured to obtain, from the video data, a coded video frame coded before the target video frame.

The set obtaining unit is specifically configured to add, if the coded video frame is played before the target video frame, the coded video frame played before the target video frame to the forward full reference frame set constructed for the target unit; or

the set obtaining unit is specifically configured to add, if the coded video frame is played after the target video frame, the coded video frame played after the target video frame to the backward full reference frame set constructed for the target unit.

A quantity of hierarchical sub-coding units is P; P is an integer greater than 1; and the P hierarchical sub-coding units includes a target hierarchical sub-coding unit.

The apparatus further includes:
a condition determining module, configured to obtain an inter prediction mode and an inter prediction direction corresponding to the target hierarchical sub-coding unit.

The condition determining module is configured to determine, if inter prediction modes respectively corresponding to the P hierarchical sub-coding units are all translational inter prediction and inter prediction directions respectively corresponding to the P hierarchical sub-coding units are all the same, that coding results of the P hierarchical sub-coding units satisfy the motion similarity condition; or
the condition determining module is configured to determine, if a hierarchical sub-coding unit of which an inter prediction mode is not translational inter prediction exists in the P hierarchical sub-coding units or inter prediction directions respectively corresponding to the P hierarchical sub-coding units are different, that coding results of the P hierarchical sub-coding units do not satisfy the motion similarity condition.

The condition determining module is specifically configured to obtain the inter prediction direction corresponding to the target hierarchical sub-coding unit. The inter prediction direction corresponding to the target hierarchical sub-coding unit includes forward prediction, backward prediction, and bidirectional prediction.

The condition determining module is specifically configured to obtain motion vectors corresponding to all pixels in the target hierarchical sub-coding unit.

The condition determining module is specifically configured to determine, if the motion vectors corresponding to all the pixels in the target hierarchical sub-coding unit are the same, translational inter prediction as the inter prediction mode corresponding to the target hierarchical sub-coding unit; or

The condition determining module is specifically configured to determine, if a pixel having a different motion vector exists in the target hierarchical sub-coding unit, non-translational inter prediction as the inter prediction mode corresponding to the target hierarchical sub-coding unit.

The apparatus further includes:
a determining module, configured to: obtain, if the coding result of the hierarchical sub-coding unit does not satisfy the motion similarity condition, the full reference frame set constructed for the target unit, and determine the full reference frame set as the candidate reference frame set corresponding to the target unit in the non-division form.

The apparatus further includes:
a parameter comparison module, configured to obtain a first rate-distortion parameter of the optimal coding mode and a second rate-distortion parameter of the non-division form.

The parameter comparison module is configured to determine, if the first rate-distortion parameter is greater than or equal to the second rate-distortion parameter, the non-division form as a final coding mode corresponding to the target unit; or
the parameter comparison module is configured to determine, if the first rate-distortion parameter is less than the second rate-distortion parameter, the optimal coding mode as the final coding mode corresponding to the target unit.

According to one aspect of embodiments of this application provides a computer device, including: a processor and a memory,
the processor and the memory being connected, the memory being configured to store a computer program, and the computer program, when executed by the processor, so that the computer device performs the method provided in embodiments of this application.

According to one aspect of embodiments of this application provides a computer-readable storage medium, having a computer program stored thereon, the computer program being loadable and executable by a processor, so that a computer device having the processor performs the method provided in embodiments of this application.

According to one aspect of embodiments of this application provides a computer program product, including a computer program, the computer program being stored in a computer-readable storage medium. A processor of a computer device reads the computer program from the computer-readable storage medium, and the processor executes the computer program, so that the computer device performs the method provided in embodiments of this application.

In view of this, embodiments of this application provide a fast reference frame selection algorithm. In the fast reference frame selection algorithm, that a reference frame of an image block (that is, a target unit to be coded) has extremely high similarity with a reference frame of a sub-block (that is, the hierarchical sub-coding unit) may be fully considered. When the same image block is divided in different manners, a plurality of reference frame selection processes may be performed. If different sub-blocks (that is, hierarchical sub-coding units) in the image block have consistent motion tracks (in other words, coding results of the hierarchical sub-coding units satisfy the motion similarity condition), there is a large probability that image content covered by the image block moves in translation as a whole. Therefore, there is a large probability that the reference frame of the image block is the same as the reference frame of the sub-block (that is, the hierarchical sub-coding unit). In this case, the full reference frame set constructed for the target unit is cropped based on the hierarchical sub-coding unit, to generate the candidate reference frame set corresponding to the target unit in the non-division form (in other words, the reference frame of the target unit is quickly selected by using a selection result of the reference frame of the hierarchical sub-coding unit generated by dividing the target unit). According to the fast reference frame selection algorithm provided in embodiments of this application, the candidate reference frame set in which the reference frame used for the hierarchical sub-coding unit is fused may be selected from all the video frames. Because the reference frame in the candidate reference frame set is determined based on the hierarchical sub-coding unit, the reference frame in the candidate reference frame set has high content similarity with the target video frame. In this way, in embodiments of this application, it is unnecessary to traverse all coded video frames (that is, video frames in the full reference frame set), but to traverse video frames in the candidate reference frame set with a smaller quantity of frames. This not only reduces traversal time, but also can obtain the target reference frame with a best coding effect from a traversal result during traversing the candidate reference frame set to which the reference frame with high content similarity belongs, so that a coding effect and coding efficiency of the target video frame can both be ensured (to be specific, the coding effect of the target video frame is improved while coding efficiency of the target video frame is ensured; and coding efficiency of the target video frame is improved while the coding effect of the target video frame is ensured).

### BRIEF DESCRIPTION OF THE DRAWINGS

To describe the technical solutions of embodiments of this application or related technologies more clearly, the following briefly introduces the accompanying drawings required for describing embodiments or related technologies. Apparently, the accompanying drawings in the following descriptions show only some embodiments of this application, and a person of ordinary skill in the art may still derive other drawings based on these accompanying drawings without creative efforts.

FIG. 1 is a schematic diagram of a structure a network architecture according to an embodiment of this application.

FIG. 2 is a schematic diagram of a scenario of data exchange according to an embodiment of this application.

FIG. 3 is a schematic flowchart of a video data processing method according to an embodiment of this application.

FIG. 4 is a schematic diagram of a scenario of dividing a to-be-coded unit according to an embodiment of this application.

FIG. 5 is a schematic diagram of a scenario of obtaining a reference frame according to an embodiment of this application.

FIG. 6 is a schematic flowchart of non-division coding according to an embodiment of this application.

FIG. 7 is a schematic flowchart of a video data processing method according to an embodiment of this application.

FIG. 8 is a schematic diagram of a scenario of division forms according to an embodiment of this application.

FIG. 9 is a schematic flowchart of a video data processing method according to an embodiment of this application.

FIG. 10 is a schematic flowchart of coding a to-be-coded unit according to an embodiment of this application.

FIG. 11 is a schematic diagram of a structure a video data processing apparatus according to an embodiment of this application.

FIG. 12 is a schematic diagram of a structure of a computer device according to an embodiment of this application.

### DESCRIPTION OF EMBODIMENTS

The technical solutions in embodiments of this application are clearly and completely described in the below with reference to the accompanying drawings in embodiments of this application. Apparently, the described embodiments are merely some rather than all of embodiments of this application. All other embodiments obtained by a person of ordinary skill in the art based on embodiments of this application without making creative efforts shall fall within the protection scope of this application.

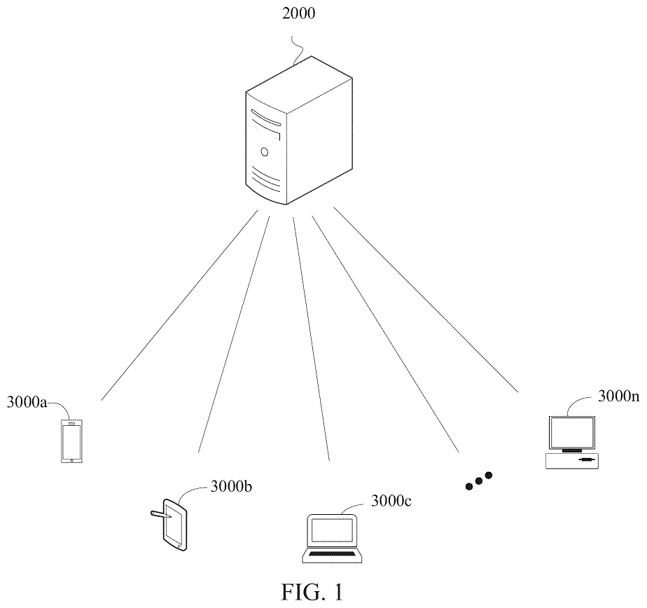

Specifically, FIG. 1 is a schematic diagram of a structure a network architecture according to an embodiment of this application. As shown in FIG. 1, the network architecture may include a server 2000 and a terminal device cluster. The terminal device cluster may specifically include one or more terminal devices, and a quantity of terminal devices in the terminal device cluster is not limited herein. As shown in FIG. 1, the plurality of terminal devices may specifically include a terminal device 3000a, a terminal device 3000b, a terminal device 3000c, . . . , and a terminal device 3000n. The terminal device 3000a, the terminal device 3000b, the terminal device 3000c, . . . , and the terminal device 3000n may be separately connected to the server 2000 directly or indirectly over a network in a wired or wireless communication manner, so that each terminal device can exchange data with the server 2000 through the network connection.

Each terminal device in the terminal device cluster may include: a smartphone, a tablet computer, a notebook computer, a desktop computer, an intelligent voice interaction device, a smart home appliance (for example, a smart TV), a wearable device, an on-board terminal, an aerial vehicle, and another intelligent terminal having a data processing capability. An application client may be installed in each terminal device in the terminal device cluster shown in FIG. 1. When the application client runs in each terminal device, each terminal device may exchange data with the server 2000. The application client may include an application client having a video coding function, such as a social client, a multimedia client (for example, a video client), an entertainment client (for example, a game client), an education client, or a livestreaming client. The application client may be an independent client, or may be an embedded subclient integrated in a client. This is not limited herein.

The server 2000 may be a server corresponding to the application client, and the server 2000 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

For ease of understanding, in this embodiment of this application, one terminal device may be selected from the plurality of terminal devices shown in FIG. 1 as a target terminal device. For example, in this embodiment of this application, the terminal device 3000c shown in FIG. 1 may be used as the target terminal device, and an application client having a video coding function may be integrated in the target terminal device. In this case, the target terminal device may exchange data with the server 2000 through the application client.

A video data processing method provided in embodiments of this application may be performed by a computer device having a video coding function, and the computer device may implement data coding and data transmission on multimedia data (for example, video data) by using a cloud technology. The video data processing method provided in embodiments of this application may be performed by the server 2000 (in other words, the computer device may be the server 2000), may be performed by the target terminal device (in other words, the computer device may be the target terminal device), or may be performed by both the server 2000 and the target terminal device. In other words, the server 2000 may code the video data by using the video data processing method provided in embodiments of this application, and then send a video bitstream obtained by coding to the target terminal device. The target terminal device may decode and play the video bitstream. Alternatively, the target terminal device may code the video data by using the video data processing method provided in embodiments of this application, and then send a video bitstream obtained by coding to the server 2000. In one embodiment, the target terminal device may alternatively send the video bitstream obtained by coding to another terminal device (for example, the terminal device 3000a) in the terminal device cluster.

The cloud technology refers to a hosting technology that integrates series of resources such as hardware, software, and network in a wide area network or a local area network, to implement computing, storage, processing, and sharing of data. The cloud technology is a general term of a network technology, an information technology, an integration technology, a management platform technology, and an application technology based on a cloud computing business model application, and may form a resource pool to satisfy what is needed in a flexible and convenient manner. A cloud computing technology may be the backbone. A large quantity of computing resources and storage resources are needed for background services in a technical network system, such as video websites, picture websites, and other portal websites. With advanced development and application of the internet industry, all objects are likely to have their own identification flag in the future. These flags need to be transmitted to a background system for logical processing. Data of different levels is to be processed separately. Therefore, data in all industries requires support of a powerful system, to be implemented through cloud computing.

The foregoing network framework is applicable to a video call scenario, a video transmission scenario, a cloud conference scenario, a live streaming scenario, a cloud gaming scenario, and the like. Specific service scenarios are not listed one by one herein. Cloud gaming may also be referred to gaming on demand, and is an online game technology based on the cloud computing technology. A cloud gaming technology enables a thin client with relatively limited graphic processing and data computing capabilities to run a high-quality game. In the cloud gaming scenario, a game is not run on a player game terminal, but is run in a cloud server, and the cloud server renders the game scenario into a video and audio stream, and transmits the video and audio stream to the player game terminal over a network. The player game terminal does not need to have powerful graphics computing and data processing capabilities, but only needs to have a basic streaming media playback capability and a capability to obtain player input instructions and send the player input instructions to the cloud server.

A cloud conference is an efficient, convenient, and low-cost conference form based on the cloud computing technology. A user only needs to perform a simple operation on an internet interface to quickly and efficiently share a speech, a data file, and a video with teams and customers all over the world synchronously. A cloud conference service provider helps the user to operate complex technologies such as data transmission and processing in the conference. Currently, domestic cloud conferences mainly focus on service content mainly in the mode of software as a service (SaaS), including a service form such as a telephone, a network, and a video. A video conference based on cloud computing is referred to as a cloud conference. In the cloud conference era, data transmission, processing, and storage are all performed by a computer resource of a video conference manufacturer, and a user no longer needs to purchase expensive hardware and install cumbersome software but only needs to open a browser to log into a corresponding interface to have an efficient remote conference. The cloud conference system supports multi-server dynamic cluster deployment and provides a plurality of high-performance servers, to greatly improve stability, security, and availability of a conference. In recent years, the video conference is widely used in various fields, such as transportation, transmission, finance, operators, education, enterprises, and internet of vehicles because of greatly improved communication efficiency, continuously reduced communication costs, and internal management upgrade. Undoubtedly, after the cloud computing is applied, video conferences become more attractive in terms of convenience, speed, and ease of usage, to surely stimulate arrival of a new climax of video conference application.

The computer device (for example, the target terminal device) having the video coding function may code video data by using a video coder, to obtain a video bitstream corresponding to the video data, thereby improving transmission efficiency of the video data. For example, the video coder may be a high efficiency video coding (HEVC) video coder, a versatile video coding (VVC) video coder, or the like. The VVC video coder is also referred to as an H.266 video coder, and a common video coding standard specifies a decoding process and syntax of decoding by the H.266 video coder and a coding process and syntax of coding by the H.266 video coder. The HEVC video coder is also referred to as an H.265 video coder.

As a coding standard, a bit rate of the H.266 video coder is approximately 50% of that of a previous generation standard HEVC at the same subjective quality. This greatly helps current massive video service data because less storage space and less bandwidth are needed for video streams of the same quality. However, coding complexity of the H.266 video coder is correspondingly increased by several times because a more complex coding tool is introduced to obtain a higher video compression ratio in the new standard. High coding complexity means that coding needs more computing resources and longer time. High coding complexity for a low delay service such as livestreaming directly degrades service experience of users. Therefore, how to reserve a rate-distortion performance of a video coder as much as possible and reduce coding complexity as much as possible is very meaningful.

For ease of understanding, in embodiments of this application, a to-be-coded video frame in the video data may be referred to as a target video frame, and a to-be-coded basic coding unit in the target video frame may be referred to as a to-be-coded unit. The to-be-coded unit may be a to-be-coded coding unit (CU), and the coding unit CU may be a basic coding unit in the H.266 video coder/H.265 video coder.

The target video frame may have different video frame types (that is, frame types), the frame type of the target video frames varies, and a reference frame selected during coding the to-be-coded unit in the target video frame varies. The frame type of the target video frame herein may include a first type, a second type, and a third type. In embodiments of this application, a frame type such as an intra picture (I frame) may be referred to as the first type, a frame type such as a bi-directional interpolated prediction frame (B frame) may be referred to as the second type, and a frame type such as a forward predictive-frame (P frame) may be referred to as the third type.

The video data in embodiments of this application may be any video data that needs to be coded in a service scenario. For example, the video data may be directly collected by an image collector (for example, a camera) in the terminal device, the video data may be recorded in real time by an image collector in the terminal device in a livestreaming/video call process, the video data may be downloaded by the terminal device on a network, or the video data may be obtained by the terminal device from a server during a game/conference.

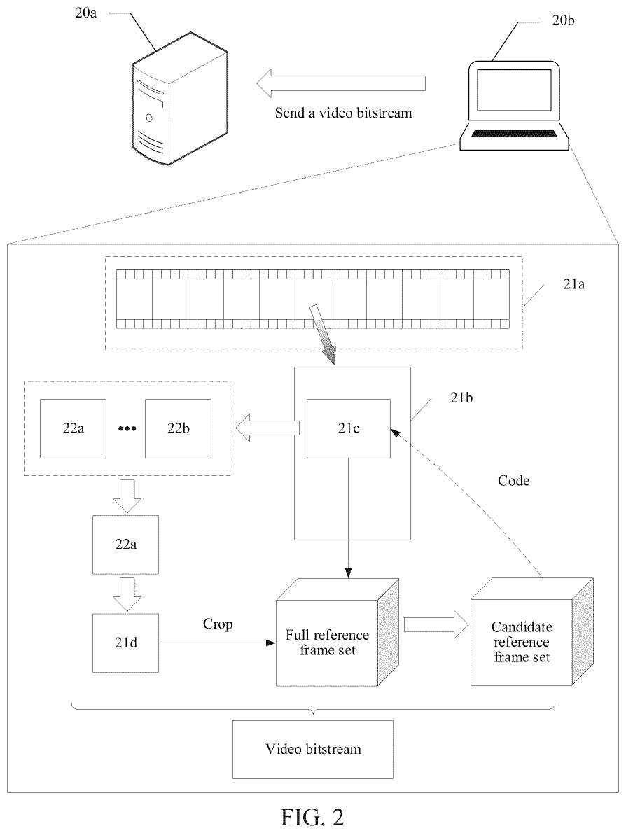

For ease of understanding, further, FIG. 2 is a schematic diagram of a scenario of data exchange according to an embodiment of this application. A server 20a shown in FIG. 2 may be the server 2000 in the embodiment corresponding to FIG. 1, and a terminal device 20b shown in FIG. 2 may be the target terminal device in the embodiment corresponding to FIG. 1. For ease of understanding, in this embodiment of this application, an example in which the terminal device 20b is a transmit end configured to send a video bitstream of video data, and the server 20a is a receive end configured to receive a video bitstream of video data is used for description.

The terminal device 20b may obtain the video data (for example, video data 21a). The video data 21a may include one or more video frames. A quantity of the video frames in the video data 21a is not limited in this embodiment of this application. Further, the terminal device 20b needs to code the video data 21a by using a video coder (for example, an H.266 video coder), to generate a video bitstream associated with the video data 21a.

As shown in FIG. 2, when coding the video data 21a, the terminal device 20b may obtain, from the video data 21a, a target video frame (for example, a video frame 21b) that needs to be coded (in other words, the video frame 21b is a video frame in the video data 21a), and then obtain a to-be-coded unit (for example, a to-be-coded unit 21c) from the video frame 21b. Further, the terminal device 20b may code the to-be-coded unit 21c according to a coding policy of the video coder, to obtain a compressed bitstream corresponding to the to-be-coded unit 21c. When completing coding on each to-be-coded unit in the target video frame, the terminal device 20b may obtain a compressed bitstream corresponding to each to-be-coded unit, so that when completing coding on each video frame in the video data 21a, the terminal device 20b may encapsulate the compressed bitstream corresponding to each to-be-coded unit into a video bitstream associated with the video data 21a, to complete coding on the video data 21a.

The coding policy of the video coder may include an intra prediction mode (that is, intra prediction coding) and an inter prediction mode (that is, inter prediction coding). The intra prediction mode and the inter prediction mode may be collectively referred to as a coding prediction technology. The intra prediction (that is, intra-frame coding) indicates that coding of a current frame does not refer to information about another frame. The inter prediction (that is, inter-frame coding) indicates that the current frame is predicted by using information about an adjacent frame. Both the intra prediction and the inter prediction are one type of coding prediction technology. When performing inter prediction on the to-be-coded unit in the target video frame, the video coder may select one frame in a forward reference frame list or a backward reference frame list as a reference frame (that is, unidirectional prediction), or may select one frame from each of the two reference frame lists, for a total of two frames, as reference frames (that is, bidirectional prediction). Selecting one frame in the forward reference frame list as the reference frame may also be referred to as forward prediction, and selecting one frame in the backward reference frame list as the reference frame may also be referred to as backward prediction. The unidirectional prediction or the bidirectional prediction may be used to perform inter prediction on a video frame of a second type (that is, a B frame), and the unidirectional prediction may be used to perform inter prediction on a video frame of a third type (that is, a P frame).

This embodiment of this application may be applied to reference frame selection for the inter prediction mode. As shown in FIG. 2, the terminal device 20b may perform recursive hierarchical division on the to-be-coded unit 21c, to obtain S hierarchical division forms for the to-be-coded unit 21c. S herein may be a positive integer, and a value of S is determined according to the coding policy of the video coder. For example, S in the H.266 video coder may be equal to 5. The S hierarchical division forms may specifically include a hierarchical division form 22a, . . . , and a hierarchical division form 22b.

Further, as shown in FIG. 2, the terminal device 20b may obtain an optimal coding mode for the to-be-coded unit from the hierarchical division form 22a, . . . , and the hierarchical division form 22b. For example, the optimal coding mode in the hierarchical division form 22a, . . . , and the hierarchical division form 22b may be the hierarchical division form 22a (that is, an optimal coding mode 22a), and the optimal coding mode 22a may be a hierarchical division form having a smallest rate-distortion performance in the hierarchical division form 22a, . . . , and the hierarchical division form 22b.

Further, as shown in FIG. 2, the terminal device 20b may obtain a hierarchical sub-coding unit corresponding to the optimal coding mode 22a. A quantity of hierarchical sub-coding units may be at least two. In this embodiment of this application, the at least two hierarchical sub-coding units corresponding to the optimal coding mode 22a may be collectively referred to as a hierarchical sub-coding unit 21d.

The terminal device 20b may obtain, from the video data 21a, a video frame coded before the video frame 21b, and determine the obtained video frame as a full reference frame set constructed for the to-be-coded unit 21c. As shown in FIG. 2, if a coding result of the hierarchical sub-coding unit 21d satisfies a motion similarity condition, the terminal device 20b may crop, based on the hierarchical sub-coding unit 21d, the full reference frame set constructed for the to-be-coded unit 21c, to generate a candidate reference frame set corresponding to the to-be-coded unit 21c in a non-division form. In one embodiment, if a coding result of the hierarchical sub-coding unit 21d does not satisfy a motion similarity condition, the terminal device 20b may determine the full reference frame set constructed for the to-be-coded unit 21c as a candidate reference frame set corresponding to the to-be-coded unit 21c in a non-division form.

Further, as shown in FIG. 2, after determining the candidate reference frame set, the terminal device 20b may traverse the candidate reference frame set to obtain a target reference frame, code the to-be-coded unit 21c based on the target reference frame, to obtain a compressed bitstream of the to-be-coded unit 21c in the non-division form, and then generate, based on the compressed bitstream of the to-be-coded unit 21c in the non-division form or a compressed bitstream of the to-be-coded unit 21c in the optimal coding mode 22a, the video bitstream associated with the video data 21a. In this case, the terminal device 20b may send the video bitstream associated with the video data 21a to the server 20a. In this way, when receiving the video bitstream, the server 20a may decode the video bitstream by using a video decoder, to obtain the video data 21a.

The compressed bitstream corresponding to the to-be-coded unit (for example, the to-be-coded unit 21c) may include, but is not limited to, a motion vector, a reference frame index, a reference frame list, and the like. The server 20a may generate an inter prediction pixel value by using information in the compressed bitstream, in other words, restore the to-be-coded unit. The reference frame index may mean an index for locating a specific reference frame in the reference frame list. A specific reference frame used during coding the to-be-coded unit may be located in the reference frame list by using the reference frame index.

It can be learned that in this embodiment of this application, when the to-be-coded unit in the target video frame needs to be coded, the optimal coding mode corresponding to the to-be-coded unit in division forms (that is, the S hierarchical division forms) is obtained, so that the hierarchical sub-coding unit corresponding to the optimal coding mode is obtained from the target video frame, and the candidate reference frame set corresponding to the to-be-coded unit in the non-division form is determined based on a reference frame used for the hierarchical sub-coding unit. The reference frame in the candidate reference frame set is a reference frame associated with the hierarchical sub-coding unit. Considering correlation between video content in the to-be-coded unit and video content in the hierarchical sub-coding unit (that is, content correlation), it may be learned that the reference frame in the candidate reference frame set has high content similarity with the target video frame to which the to-be-coded unit belongs. In this way, during coding the to-be-coded unit in the target video frame based on the candidate reference frame set, the candidate reference frame set may be traversed, rather than traversing all coded video frames. In this way, not only a coding effect of the target video frame can be ensured, but also selection for the reference frame can be simplified. A proportion of complexity that reference frame decision-making (that is, reference frame selection) contributes to an overall coding process is effectively reduced, to reduce calculation complexity of an inter-frame coding process of the video coder, thereby reducing coding time (in other words, improving coding efficiency) and overheads of calculation resources and bandwidth resources.

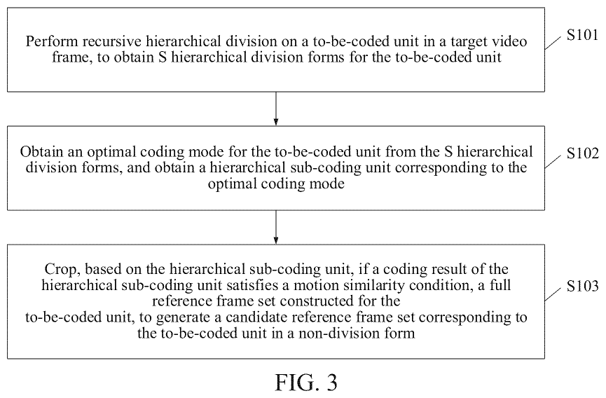

For a specific implementation that a computer device having a video coding function determines the candidate reference frame set in the video data, refer to the following embodiments corresponding to FIG. 3 to FIG. 10.

Further, FIG. 3 is a schematic flowchart of a video data processing method according to an embodiment of this application. The method may be performed by a server, may be performed by a terminal device, or may be performed by both a server and a terminal device. The server may be the server 20a in the embodiment corresponding to FIG. 2, and the terminal device may be the terminal device 20b in the embodiment corresponding to FIG. 2. For ease of understanding, in this embodiment of this application, an example in which the method is performed by the terminal device is used for description. The video data processing method may include the following operation S101 to operation S103.

Operation S101: Perform recursive hierarchical division on a to-be-coded unit in a target video frame, to obtain S hierarchical division forms for the to-be-coded unit.

S herein may be a positive integer, and the target video frame is a video frame in video data. In other words, the terminal device may obtain a to-be-coded video frame from video data, and determine the obtained video frame as the target video frame. Further, the terminal device may perform image block division (that is, block division) on the target video frame by using a video coder, to obtain one or more image blocks (that is, coding blocks) of the target video frame, and then obtain the to-be-coded unit from the one or more image blocks. An objective of the image block division is to process prediction more precisely. A relatively small image block is used on a tiny moving part, and a relatively large image block is used on a static background. In this embodiment of this application, a coding unit CU may be referred to as an image block. Prediction and reference frame selection are performed during block division.

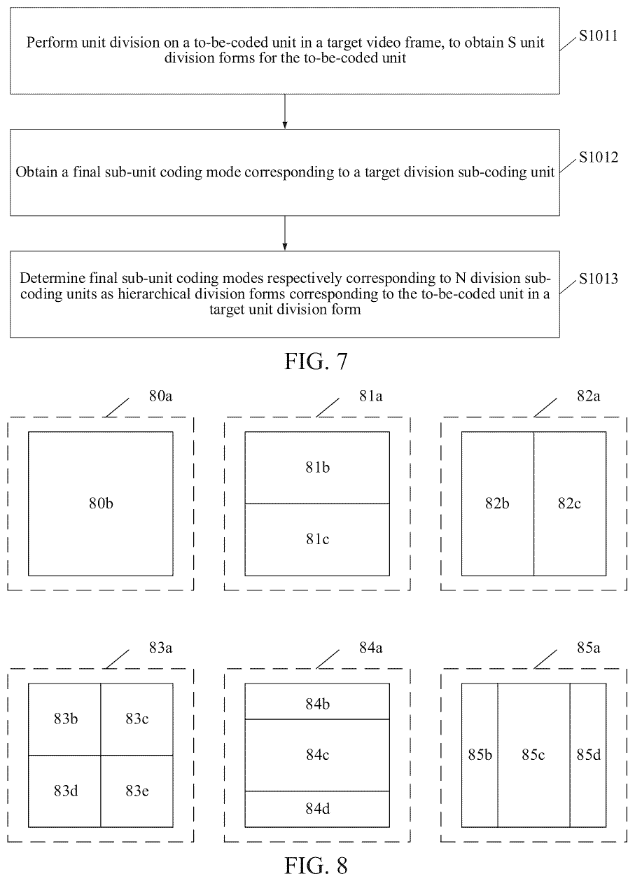

For a specific process of performing the recursive hierarchical division on the to-be-coded unit in the target video frame, to obtain the S hierarchical division forms for the to-be-coded unit, refer to descriptions of operation S1011 to operation S1013 in the following embodiment corresponding to FIG. 7.

Operation S102: Obtain an optimal coding mode for the to-be-coded unit from the S hierarchical division forms, and obtain a hierarchical sub-coding unit corresponding to the optimal coding mode.

Specifically, the terminal device may obtain the optimal coding mode for the to-be-coded unit from the S hierarchical division forms. The terminal device may obtain rate-distortion performances respectively corresponding to the S hierarchical division forms, and determine a hierarchical division form corresponding to a smallest rate-distortion performance in the S rate-distortion performances as the optimal coding mode for the to-be-coded unit. The optimal coding mode includes M division sub-coding units of the to-be-coded unit. M herein may be an integer greater than 1, and the M division sub-coding units include an auxiliary division sub-coding unit. Further, if the auxiliary division sub-coding unit has no sub-coding unit, the terminal device may determine the auxiliary division sub-coding unit as the hierarchical sub-coding unit corresponding to the optimal coding mode. In one embodiment, if the auxiliary division sub-coding unit has sub-coding units, the terminal device may obtain the hierarchical sub-coding unit corresponding to the optimal coding mode from the auxiliary division sub-coding unit.

For a specific process of obtaining the hierarchical sub-coding unit corresponding to the optimal coding mode from the auxiliary division sub-coding unit, refer to the foregoing descriptions of obtaining the hierarchical sub-coding unit corresponding to the optimal coding mode from the to-be-coded unit. Details are not described herein again.

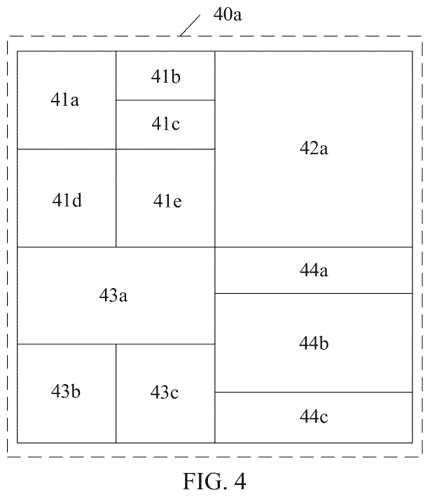

For ease of understanding, FIG. 4 is a schematic diagram of a scenario of dividing a to-be-coded unit according to an embodiment of this application. Image block division section 40a shown in FIG. 4 may be image block division of a to-be-coded unit obtained from video data. Image block division section 40a may be a schematic diagram obtained through image block division by using an H.266 video coder. The schematic diagram obtained through image block division is not limited in this embodiment of this application. An example in which the schematic diagram obtained through image block division is image block division section 40a is used for description. For another image block division obtained by using the video coder, refer to the descriptions of image block division section 40a.

As shown in FIG. 4, image block division section 40a shows that the to-be-coded unit may be divided into (an image block 41a, an image block 41b, an image block 41c, an image block 41d, and an image block 41e), (an image block 42a), (an image block 43a, an image block 43b, and an image block 43c), and (an image block 44a, an image block 44b, and an image block 44c).

(The image block 41a, the image block 41b, the image block 41c, the image block 41d, and the image block 41e) may be divided into (the image block 41a), (the image block 41b and the image block 41c), (the image block 41d), and (the image block 41e). (The image block 41b and the image block 41c) may be divided into (the image block 41b) and (the image block 41c). In one embodiment, (the image block 41a, the image block 41b, the image block 41c, the image block 41d, and the image block 41e) may be divided into (the image block 41a, the image block 41b, and the image block 41c) and (the image block 41d and the image block 41e). (The image block 41a, the image block 41b, and the image block 41c) may be divided into (the image block 41a) and (the image block 41b and the image block 41c). (The image block 41d and the image block 41e) may be divided into (the image block 41d) and (the image block 41e). (The image block 41b and the image block 41c) may be divided into (the image block 41b) and (the image block 41c). In one embodiment, (the image block 41a, the image block 41b, the image block 41c, the image block 41d, and the image block 41e) may be divided into (the image block 41a and the image block 41d) and (the image block 41b, the image block 41c, and the image block 41e). (The image block 41a and the image block 41d) may be divided into (the image block 41a) and (the image block 41d). (The image block 41b, the image block 41c, and the image block 41e) may be divided into (the image block 41b and the image block 41c) and (the image block 41e). (The image block 41b and the image block 41c) may be divided into (the image block 41b) and (the image block 41c). Similarly, the terminal device may divide (the image block 43a, the image block 43b, and the image block 43c) and (the image block 44a, the image block 44b, and the image block 44c). Details are not described herein again.

All the image blocks in image block division section 40a may be organized into a search tree (different image block divisions may correspond to different search trees). The video coder may traverse the block division tree (that is, the search tree) in a top-down recursive process to determine a final division form of the current image block. In the search tree, a parent node may be a parent coding unit (that is, a parent CU), and a child node may be a child coding unit (that is, a child CU). The parent coding unit and the child coding unit are relative.

In one embodiment, image block division section 40a shows that the to-be-coded unit may be divided into (the image block 41a, the image block 41b, the image block 41c, the image block 41d, the image block 41e, and the image block 42a) and (the image block 43a, the image block 43b, the image block 43c, the image block 44a, the image block 44b, and the image block 44c). In one embodiment, image block division section 40a shows that the target video frame may be divided into (the image block 41a, the image block 41b, the image block 41c, the image block 41d, the image block 41e, the image block 43a, the image block 43b, and the image block 43c) and (the image block 42a, the image block 44a, the image block 44b, and the image block 44c).

For ease of understanding, image block division section 40a may be image block division corresponding to the optimal coding mode. In this case, the hierarchical sub-coding unit corresponding to the optimal coding mode may include the image block 41a, the image block 41b, the image block 41c, the image block 41d, the image block 41e, the image block 42a, the image block 43a, the image block 43b, the image block 43c, the image block 44a, the image block 44b, and the image block 44c. The M division sub-coding units of the to-be-coded unit may include (the image block 41a, the image block 41b, the image block 41c, the image block 41d, and the image block 41e), (the image block 42a), (the image block 43a, the image block 43b, and the image block 43c), and (the image block 44a, the image block 44b, and the image block 44c). In other words, M is equal to 4.

The H.266 video coder/An H.265 video coder performs coding in block division. During coding, one image block is divided into a plurality of CUs. A CU may be divided in a nested manner. One CU, as a new image block, may be continuously divided into a plurality of CUs until a minimum size limit of the CU is reached. Therefore, the CU is a basic unit for coding prediction.

Operation S103: Crop, based on the hierarchical sub-coding unit, if a coding result of the hierarchical sub-coding unit satisfies a motion similarity condition, a full reference frame set constructed for the to-be-coded unit, to generate a candidate reference frame set corresponding to the to-be-coded unit in a non-division form.

Specifically, if the coding result of the hierarchical sub-coding unit satisfies the motion similarity condition, the terminal device may obtain, from the video data, the full reference frame set constructed for the to-be-coded unit. The full reference frame set includes a forward full reference frame set and a backward full reference frame set. In other words, the forward full reference frame set and the backward full reference frame set may be collectively referred to as the full reference frame set. In other words, the terminal device may obtain, from the video data, the forward full reference frame set and the backward full reference frame set that are constructed for the to-be-coded unit. Further, the terminal device may select, in the forward full reference frame set, a reference frame used for the hierarchical sub-coding unit, and determine, if the reference frame used for the hierarchical sub-coding unit exists in the forward full reference frame set, the reference frame selected in the forward full reference frame set as a forward candidate reference frame set corresponding to the to-be-coded unit in the non-division form. The terminal device may select, in the backward full reference frame set, a reference frame used for the hierarchical sub-coding unit, and determine, if the reference frame used for the hierarchical sub-coding unit exists in the backward full reference frame set, the reference frame selected in the backward full reference frame set as a backward candidate reference frame set corresponding to the to-be-coded unit in the non-division form. The candidate reference frame set includes the forward candidate reference frame set and the backward candidate reference frame set. In other words, the forward candidate reference frame set and the backward candidate reference frame set may be collectively referred to as the candidate reference frame set. The candidate reference frame set is configured for obtaining a target reference frame for the to-be-coded unit through traversal. The target reference frame is configured for coding the to-be-coded unit.

In other words, the terminal device may match the reference frame used for the hierarchical sub-coding unit with the full reference frame set. Further, if there is an intersection set between the reference frame used for the hierarchical sub-coding unit and a reference frame in the full reference frame set, the terminal device may determine the intersection set between the reference frame used for the hierarchical sub-coding unit and the reference frame in the full reference frame set as the candidate reference frame set corresponding to the to-be-coded unit in the non-division form. In one embodiment, if there is no intersection between the reference frame used for the hierarchical sub-coding unit and a reference frame in the full reference frame set, the terminal device may determine the full reference frame set as the candidate reference frame set corresponding to the to-be-coded unit in the non-division form.

In a coding standard, if default reference frame lists (that is, full reference frame sets) generated by coding units in the same frame are the same, a reference frame list obtained through cropping (that is, the candidate reference frame set) is certainly a subset of the default reference frame list, and the cropping indicates that the to-be-coded unit may use the reference frame used for the hierarchical sub-coding unit. In this case, if the coding result of the hierarchical sub-coding unit satisfies the motion similarity condition, the terminal device may determine the reference frame used for the hierarchical sub-coding unit as the candidate reference frame set corresponding to the to-be-coded unit in the non-division form, to be specific, add a video frame that is in the reference frame used for the hierarchical sub-coding unit and that is played before the target video frame to the forward candidate reference frame set, and add a video frame that is in the reference frame used for the hierarchical sub-coding unit and that is played after the target video frame to the backward candidate reference frame set.

A specific process in which the terminal device obtains, from the video data, the forward full reference frame set and the backward full reference frame set that are constructed for the to-be-coded unit may be described as: The terminal device may obtain, from the video data, a coded video frame coded before the target video frame. Further, if the coded video frame is played before the target video frame, the terminal device may add the coded video frame played before the target video frame to the forward full reference frame set constructed for the to-be-coded unit; or if the coded video frame is played after the target video frame, the terminal device may add the coded video frame played after the target video frame to the backward full reference frame set constructed for the to-be-coded unit. In other words, the terminal device may add the coded video frame played before the target video frame to the forward full reference frame set, and add the coded video frame played after the target video frame to the backward full reference frame set.

When inter prediction is performed, the video coder may construct a reference frame list for the target video frame. The reference frame list includes two parts. One part is a forward reference frame list (that is, the forward full reference frame set), and the other part is a backward reference frame list (that is, the backward full reference frame set). The forward reference frame list includes a video frame both coded and played before a current frame (that is, the target video frame), and the backward reference frame list includes a video frame coded before the current frame (that is, the target video frame) and played after the current frame (that is, the target video frame). A quantity of video frames in the reference frame list is not limited in this embodiment of this application.

A quantity of hierarchical sub-coding units is P, and P herein may be an integer greater than 1. The terminal device may determine a union set of reference frames used for the P hierarchical sub-coding units as an associated reference frame set. The terminal device may determine a reference frame that is in the associated reference frame set and that is played before the target video frame as a forward associated reference frame set, and determine a reference frame that is in the associated reference frame set and that is played after the target video frame as a backward associated reference frame set. The forward associated reference frame set and the backward associated reference frame set may be collectively referred to as the associated reference frame set. In other words, the terminal device may add a reference frame that is of the reference frames used for the P hierarchical sub-coding units and that is played before the target video frame to the forward associated reference frame set, and add a reference frame that is of the reference frames used for the P hierarchical sub-coding units and that is played after the target video frame to the backward associated reference frame set. Therefore, the terminal device may determine an intersection set of the forward associated reference frame set and the forward full reference frame set as the forward candidate reference frame set corresponding to the to-be-coded unit in the non-division form, and determine an intersection set of the backward associated reference frame set and the backward full reference frame set as the backward candidate reference frame set corresponding to the to-be-coded unit in the non-division form.

For ease of understanding, in this embodiment of this application, an example in which the forward associated reference frame set includes the reference frame played before the target video frame, and the backward associated reference frame set includes the reference frame played after the target video frame is used for description. In one embodiment, if the forward associated reference frame set does not include a reference frame (that is, the associated reference frame set does not include the reference frame played before the target video frame), the terminal device may determine that the forward candidate reference frame set corresponding to the to-be-coded unit in the non-division form is an empty set, or determine the forward full reference frame set as the forward candidate reference frame set corresponding to the to-be-coded unit in the non-division form. If the backward associated reference frame set does not include a reference frame (that is, the associated reference frame set does not include the reference frame played after the target video frame), the terminal device may determine that the backward candidate reference frame set corresponding to the to-be-coded unit in the non-division form is an empty set, or determine the backward full reference frame set as the backward candidate reference frame set corresponding to the to-be-coded unit in the non-division form.

For ease of understanding, in this embodiment of this application, an example in which the forward full reference frame set includes the coded video frame played before the target video frame, and the backward full reference frame set includes the coded video played after the target video frame is used for description.

For example, an example in which P is equal to 3 is used for description herein. The P hierarchical sub-coding units may include a hierarchical sub-coding unit P1, a hierarchical sub-coding unit P2, and a hierarchical sub-coding unit P3. Bidirectional prediction is used in all the hierarchical sub-coding unit P1, the hierarchical sub-coding unit P2, and the hierarchical sub-coding unit P3. Forward reference frames and backward reference frames used for the hierarchical sub-coding unit P1, the hierarchical sub-coding unit P2, and the hierarchical sub-coding unit P3 are respectively (x0, y0), (x0, y1), and (x1, y2). Therefore, when the to-be-coded unit is coded in the non-division, the forward reference frame list (that is, the forward candidate reference frame set) is cropped to {x0, x1}, and the backward reference frame list (that is, the backward candidate reference frame set) is cropped to {y0, y1, y2}.

In one embodiment, in this embodiment of this application, a size of the to-be-coded unit may be limited (in other words, a size limit is added). For example, when a quantity of pixels of the to-be-coded unit exceeds a pixel threshold (for example, 512), a quick policy provided in this embodiment of this application is executed, and the quick policy is operation S101 to operation S103 in this embodiment of this application.

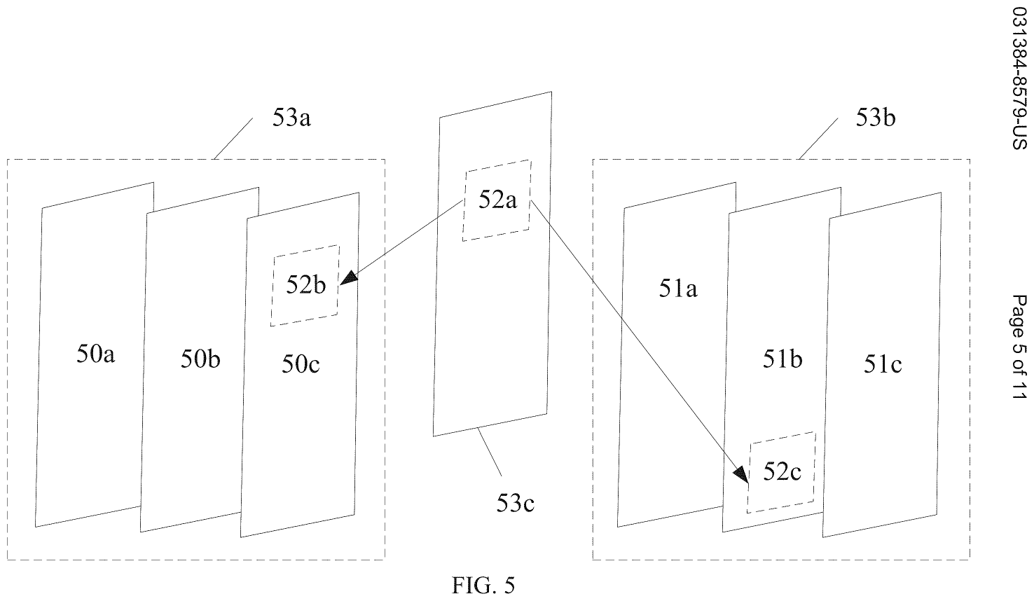

For ease of understanding, FIG. 5 is a schematic diagram of a scenario of obtaining a reference frame according to an embodiment of this application. FIG. 5 is a schematic diagram of bidirectional prediction of a to-be-coded unit. A video frame 53c may be a target video frame, a video frame set 53a may be a forward candidate reference frame set (that is, a forward candidate reference frame set 53a) corresponding to the target video frame 53c, and a video frame set 53b may be a backward candidate reference frame set (that is, a backward candidate reference frame set 53b) corresponding to the target video frame 53c.

The forward candidate reference frame set 53a may include a plurality of video frames, and the backward candidate reference frame set 53b may include a plurality of video frames. A quantity of the video frames in the forward candidate reference frame set 53a is not limited in this embodiment of this application, and a quantity of the video frames in the backward candidate reference frame set 53b is not limited in this embodiment of this application. For ease of understanding, in this embodiment of this application, an example in which the forward candidate reference frame set 53a and the backward candidate reference frame set 53b each include three video frames is used for description. The forward candidate reference frame set 53a may include a video frame 50a, a video frame 50b, and a video frame 50c, and the backward candidate reference frame set 53b may include a video frame 51a, a video frame 51b, and a video frame 51c.

As shown in FIG. 5, the target video frame 53c may include a to-be-coded unit 52a, the video frame 50c may include a coding unit 52b, and the video frame 51b may include a coding unit 52c. When the video frame 50c and the video frame 51b are determined as reference frames used for the target video frame, a video coder may code the to-be-coded unit 52a based on the coding unit 52b and the coding unit 52c. In this case, one frame is selected from each of the forward candidate reference frame set 53a and the backward candidate reference frame set 53b for the to-be-coded unit 52a as reference frames (for example, the video frame 50c and the video frame 51b) and a motion search is performed. The coding unit 52b and the coding unit 52c may be referred to as reference blocks.

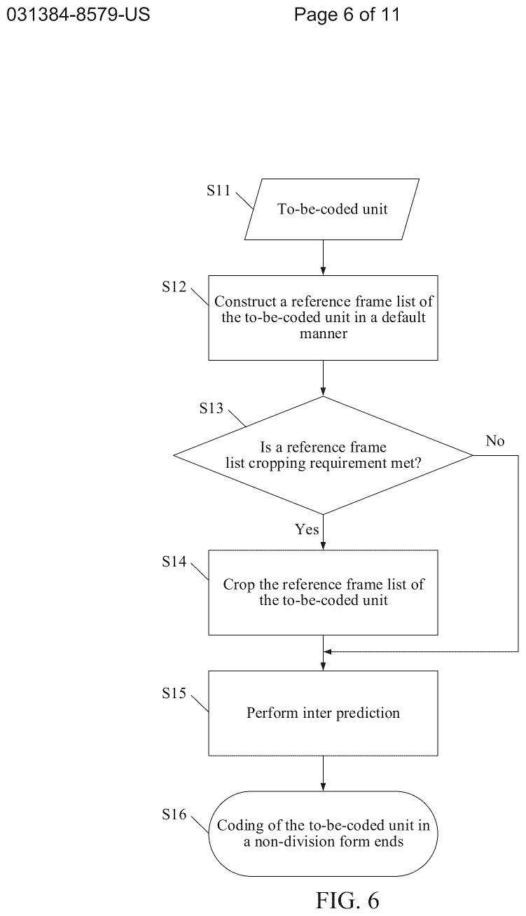

For ease of understanding, FIG. 6 is a schematic flowchart of non-division coding according to an embodiment of this application. As shown in FIG. 6, a terminal device may perform operation S11, to obtain a to-be-coded unit from a target video frame in operation S11. Further, the terminal device may perform operation S12, to construct a reference frame list (that is, a full reference frame set) of the to-be-coded unit in a default manner in operation S12. In other words, the terminal device may obtain, from video data, the full reference frame set constructed for the to-be-coded unit.

Further, as shown in FIG. 6, the terminal device may perform operation S13, to determine whether the to-be-coded unit meets a reference frame list cropping requirement in operation S13. In other words, the terminal device may determine whether a coding result of a hierarchical sub-coding unit satisfies a motion similarity condition. If the coding result of the hierarchical sub-coding unit satisfies the motion similarity condition, the to-be-coded unit meets the reference frame list cropping requirement. In one embodiment, if the coding result of the hierarchical sub-coding unit does not satisfy the motion similarity condition, the to-be-coded unit does not meet the reference frame list cropping requirement.

As shown in FIG. 6, if the to-be-coded unit meets the reference frame list cropping requirement, the terminal device may perform operation S14, and crop the reference frame list of the to-be-coded unit in operation S14. In other words, the terminal device may crop, based on the hierarchical sub-coding unit, the full reference frame set constructed for the to-be-coded unit. In one embodiment, if the to-be-coded unit does not meet the reference frame list cropping requirement, the terminal device may not perform operation S14.

Further, as shown in FIG. 6, the terminal device may perform operation S15 to perform inter prediction on the to-be-coded unit in operation S15. To be specific, after generating a candidate reference frame set corresponding to the to-be-coded unit in a non-division form, the terminal device obtains a target reference frame through traversal in the candidate reference frame set, and codes the to-be-coded unit based on the target reference frame. Further, the terminal device may perform operation S16. Operation S16 indicates ending of coding the to-be-coded unit in the non-division form.

The terminal device may obtain a coding policy of a video coder (for example, an H.266 video coder), and code the to-be-coded unit according to the coding policy of the video coder. A coding mode associated with the coding policy may include an inter prediction mode and an intra prediction mode. In this way, when performing inter prediction on the to-be-coded unit, the terminal device may determine, based on a frame type of the target video frame, a reference video frame associated with the to-be-coded unit. Different video compression standards may correspond to different reference video frames. If the frame type of the target video frame is a B frame (that is, a second type) or a P frame (that is, a third type), the terminal device may perform operation S101 to operation S103. In one embodiment, if the frame type of the target video frame is an I frame (that is, a first type), the terminal device does not need to perform operation S101 to operation S103.

In view of this, embodiments of this application provide a fast reference frame selection algorithm. In the fast reference frame selection algorithm, that a reference frame of an image block (that is, the to-be-coded unit) has extremely high similarity with a reference frame of a sub-block (that is, the hierarchical sub-coding unit) may be fully considered. When the same image block is divided in different manners, a plurality of reference frame selection processes may be performed. If different sub-blocks (that is, hierarchical sub-coding units) in the image block have consistent motion tracks (in other words, coding results of the hierarchical sub-coding units satisfy the motion similarity condition), there is a large probability that image content covered by the image block moves in translation as a whole. Therefore, there is a large probability that the reference frame of the image block is the same as the reference frame of the sub-block (that is, the hierarchical sub-coding unit). In this case, the full reference frame set constructed for the to-be-coded unit is cropped based on the hierarchical sub-coding unit, to generate the candidate reference frame set corresponding to the to-be-coded unit in the non-division form (in other words, the reference frame of the to-be-coded unit is quickly selected by using a selection result of the reference frame of the hierarchical sub-coding unit generated by dividing the to-be-coded unit). According to the fast reference frame selection algorithm provided in embodiments of this application, the candidate reference frame set in which the reference frame used for the hierarchical sub-coding unit is fused may be selected from all the video frames. Because the reference frame in the candidate reference frame set is determined based on the hierarchical sub-coding unit, the reference frame in the candidate reference frame set has high content similarity with the target video frame. In this way, in embodiments of this application, it is unnecessary to traverse all coded video frames (that is, video frames in the full reference frame set), but to traverse video frames in the candidate reference frame set with a smaller quantity of frames. This not only reduces traversal time, but also can obtain the target reference frame with a best coding effect from a traversal result during traversing the candidate reference frame set to which the reference frame with high content similarity belongs, so that a coding effect and coding efficiency of the target video frame can both be ensured (to be specific, the coding effect of the target video frame is improved while coding efficiency of the target video frame is ensured; and coding efficiency of the target video frame is improved while the coding effect of the target video frame is ensured).

Further, FIG. 7 is a schematic flowchart of a video data processing method according to an embodiment of this application. The video data processing method may include the following operation S1011 to operation S1013, and operation S1011 to operation S1013 are a specific embodiment of operation S101 in the embodiment corresponding to FIG. 3.

Operation S1011: Perform unit division on a to-be-coded unit in a target video frame, to obtain S unit division forms for the to-be-coded unit.

The S unit division forms include a target unit division form. The target unit division form includes N division sub-coding units of the to-be-coded unit. N herein may be an integer greater than 1, the N division sub-coding units include a target division sub-coding unit, and the target division sub-coding unit may be used as a new to-be-coded unit.

For ease of understanding, FIG. 8 is a schematic diagram of a scenario of division forms according to an embodiment of this application. FIG. 8 is a schematic diagram of a to-be-coded unit in S unit division forms and in a non-division form. For example, the schematic diagram shown in FIG. 8 may show six division forms specified by an H.266 video coder. Section 80a may represent a non-division schematic diagram, section 81a may represent a horizontal two-division schematic diagram, section 82a may represent a vertical two-division schematic diagram, section 83a may represent a four-division schematic diagram, section 84a may represent a horizontal three-division schematic diagram, and section 85a may represent a vertical three-division schematic diagram.

As shown in FIG. 8, in section 80a, the to-be-coded unit may be divided into a single image block, in 81a and section 82a, the to-be-coded unit may be divided into two image blocks, in 84a and section 85a, the to-be-coded unit may be divided into three image blocks, and in section 83a, the to-be-coded unit may be divided into four image blocks.

Section 80a may be divided into an image block 80b. Section 81a may be divided into an image block 81b and an image block 81c. Section 82a may be divided into an image block 82b and an image block 82c. Section 84a may be divided into an image block 84b, an image block 84c, and an image block 84d. Section 85a may be divided into an image block 85b, an image block 85c, and an image block 85d. Section 83a may be divided into an image block 83b, an image block 83c, an image block 83d, and an image block 83e.

In other words, if the target unit division form is section 81a, the N division sub-coding units corresponding to the target unit division form may specifically include the image block 81b and the image block 81c. In other words, N is equal to 2. If the target unit division form is section 82a, the N division sub-coding units corresponding to the target unit division form may specifically include the image block 82b and the image block 82c. In other words, N is equal to 2. If the target unit division form is section 84a, the N division sub-coding units corresponding to the target unit division form may specifically include the image block 84b, the image block 84c, and the image block 84d. In other words, N is equal to 3. If the target unit division form is section 85a, the N division sub-coding units corresponding to the target unit division form may specifically include the image block 85b, the image block 85c, and the image block 85d. In other words, N is equal to 3. If the target unit division form is section 83a, the N division sub-coding units corresponding to the target unit division form may specifically include the image block 83b, the image block 83c, the image block 83d, and the image block 83e. In other words, N is equal to 4.

In addition to the non-division form shown in section 80a, another sub-block (where the sub-block may also be referred to as an image block) obtained through division may further be divided in the six manners until a division limit on a block size is reached. For example, the image block 81b may continue to be divided based on section 82a. For another example, the image block 81b may continue to be divided based on section 80a (that is, the image block 81b is in the non-division form).

Operation S1012: Obtain a final sub-unit coding mode corresponding to the target division sub-coding unit.

Specifically, if the target division sub-coding unit satisfies a unit division condition, a division forms terminal device may perform recursive hierarchical division on the target division sub-coding unit, to obtain S sub-unit hierarchical division forms for the target division sub-coding unit. Further, the terminal device may obtain an optimal sub-unit coding mode for the target division sub-coding unit from the S sub-unit hierarchical division forms, and obtain a sub-unit hierarchical sub-coding unit corresponding to the optimal sub-unit coding mode. Further, if a sub-unit coding result of the sub-unit hierarchical sub-coding unit satisfies a motion similarity condition, the terminal device may crop, based on the sub-unit hierarchical sub-coding unit, a sub-unit full reference frame set constructed for the target division sub-coding unit, to generate a sub-unit candidate reference frame set corresponding to the target division sub-coding unit in the non-division form. The sub-unit candidate reference frame set is configured for obtaining a sub-unit target reference frame for the target division sub-coding unit through traversal. The sub-unit target reference frame is configured for coding the target division sub-coding unit. Further, the terminal device may obtain, from the optimal sub-unit coding mode and the non-division form, the final sub-unit coding mode corresponding to the target division sub-coding unit.

For a specific process in which the terminal device performs the recursive hierarchical division on the target division sub-coding unit, to obtain the S sub-unit hierarchical division forms for the target division sub-coding unit, refer to the foregoing descriptions of performing the recursive hierarchical division on the to-be-coded unit, to obtain the S hierarchical division forms for the to-be-coded unit. Details are not described herein again.

For a specific process in which the terminal device obtains the optimal sub-unit coding mode for the target division sub-coding unit from the S sub-unit hierarchical division forms, refer to the foregoing descriptions of obtaining the optimal coding mode for the to-be-coded unit from the S hierarchical division forms. Details are not described herein again. For a specific process in which the terminal device obtains the sub-unit hierarchical sub-coding unit corresponding to the optimal sub-unit coding mode, refer to the foregoing descriptions of obtaining the hierarchical sub-coding unit corresponding to the optimal coding mode. Details are not described herein again.

For a specific process of cropping the sub-unit full reference frame set based on the sub-unit hierarchical sub-coding unit, to generate the sub-unit candidate reference frame set, refer to the foregoing descriptions of cropping the full reference frame set based on the hierarchical sub-coding unit, to generate the candidate reference frame set. Details are not described herein again.

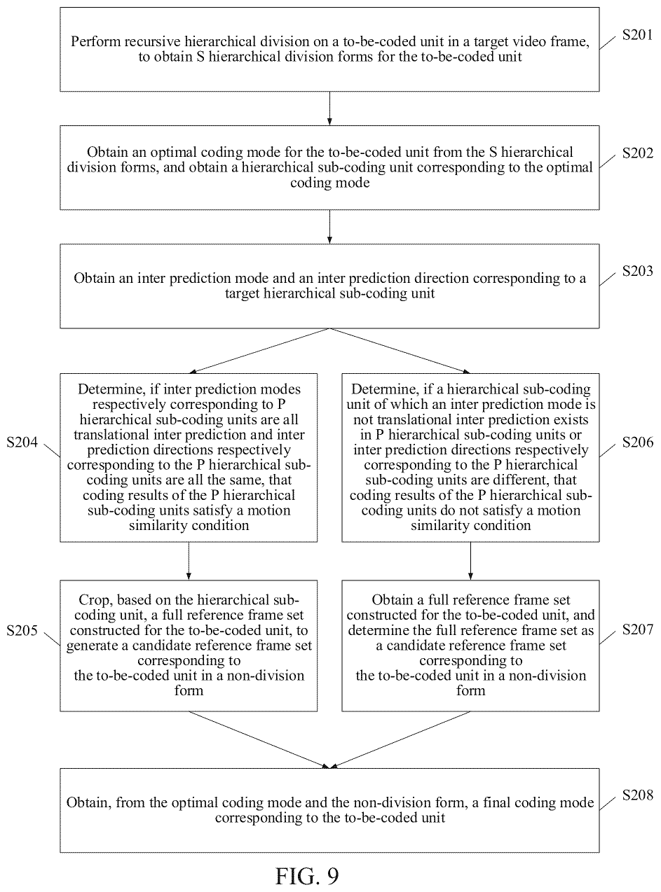

For a specific process of obtaining, from the optimal sub-unit coding mode and the non-division form, the final sub-unit coding mode corresponding to the target division sub-coding unit, refer to the following descriptions of obtaining, from an optimal coding mode and a non-division form, a final coding mode corresponding to a to-be-coded unit in the embodiment corresponding to FIG. 9.

The terminal device may obtain a sub-unit size of the target division sub-coding unit. Further, if the sub-unit size is greater than or equal to a size threshold, the terminal device may determine that the target division sub-coding unit satisfies the unit division condition. In one embodiment, if the sub-unit size is less than a size threshold, the terminal device may determine that the target division sub-coding unit does not satisfy the unit division condition. Therefore, the unit division condition is a condition that the obtained sub-unit size of the target division sub-coding unit is greater than or equal to the size threshold. A specific value of the size threshold is not limited in this embodiment of this application.

In one embodiment, if the target division sub-coding unit does not satisfy the unit division condition, the terminal device may determine the non-division form as the final sub-unit coding mode corresponding to the target division sub-coding unit.

Operation S1013: Determine final sub-unit coding modes respectively corresponding to the N division sub-coding units as hierarchical division forms corresponding to the to-be-coded unit in the target unit division form.

The S hierarchical division forms may be recursively generated form the S unit division forms, and one hierarchical division form may be recursively generated from one unit division form. For a specific process in which the terminal device determines hierarchical division forms corresponding to the to-be-coded unit in other unit division forms than the target unit division form in the S unit division forms, refer to the descriptions of determining the hierarchical division forms corresponding to the to-be-coded unit in the target unit division form. Details are not described herein again.

The hierarchical division form corresponding to the to-be-coded unit in the target unit division form may be the optimal coding mode in the embodiment corresponding to FIG. 3, or the hierarchical division form corresponding to the to-be-coded unit in the target unit division form may not be the optimal coding mode in the embodiment corresponding to FIG. 3. For ease of understanding, refer to FIG. 4. If image block division section 40a is image block division corresponding to the optimal coding mode, and the hierarchical division form corresponding to the to-be-coded unit in the target unit division form is the optimal coding mode in the embodiment corresponding to FIG. 3, image block division section 40a is image block division of the hierarchical division form corresponding to the to-be-coded unit in the target unit division form.

In view of this, in this embodiment of this application, unit division may be performed on the to-be-coded unit in the target video frame, to obtain the S unit division forms for the to-be-coded unit, and then hierarchical division forms respectively corresponding to the to-be-coded unit in the S unit division forms are determined in a recursive manner. The S hierarchical division forms indicate an optimal coding result of the to-be-coded unit in the S unit division forms, and the optimal coding mode indicates an optimal coding result of the to-be-coded unit in the S hierarchical division forms. In this way, when the candidate reference frame set of the to-be-coded unit in the non-division form is determined based on the optimal coding mode, accuracy of the obtained candidate reference frame set may be improved.

Further, FIG. 9 is a schematic flowchart of a video data processing method according to an embodiment of this application. The method may be performed by a server, may be performed by a terminal device, or may be performed by both a server and a terminal device. The server may be the server 20a in the embodiment corresponding to FIG. 2, and the terminal device may be the terminal device 20b in the embodiment corresponding to FIG. 2. For ease of understanding, in this embodiment of this application, an example in which the method is performed by the terminal device is used for description. The video data processing method may include the following operation S201 to operation S208.

Operation S201: Perform recursive hierarchical division on a to-be-coded unit in a target video frame, to obtain S hierarchical division forms for the to-be-coded unit.

S herein may be a positive integer. The target video frame is a video frame in video data. For a specific process in which the terminal device performs the recursive hierarchical division on the to-be-coded unit in the target video frame, to obtain the S hierarchical division forms for the to-be-coded unit, refer to the foregoing descriptions of operation S1011 to operation S1013 in the embodiment corresponding to FIG. 7. Details are not described herein again.

Operation S202: Obtain an optimal coding mode for the to-be-coded unit from the S hierarchical division forms, and obtain a hierarchical sub-coding unit corresponding to the optimal coding mode.

A quantity of hierarchical sub-coding units is P, and P herein may be an integer greater than 1. The P hierarchical sub-coding units include a target hierarchical sub-coding unit. For a specific process of obtaining the optimal coding mode for the to-be-coded unit from the S hierarchical division forms and obtaining the hierarchical sub-coding unit corresponding to the optimal coding mode, refer to the foregoing descriptions of operation S102 in the embodiment corresponding to FIG. 3. Details are not described herein again.

Operation S203: Obtain an inter prediction mode and an inter prediction direction corresponding to the target hierarchical sub-coding unit.

Specifically, the terminal device may obtain the inter prediction direction corresponding to the target hierarchical sub-coding unit. The inter prediction direction corresponding to the target hierarchical sub-coding unit includes forward prediction, backward prediction, and bidirectional prediction. Further, the terminal device may obtain motion vectors corresponding to all pixels in the target hierarchical sub-coding unit. The motion vector may be a vector indicating an offset vector between a position in a video frame and a position in a reference frame, that is, a vector that marks a position relationship between a current block and a reference block during inter prediction. Further, if the motion vectors corresponding to all the pixels in the target hierarchical sub-coding unit are the same, the terminal device may determine translational inter prediction as the inter prediction mode corresponding to the target hierarchical sub-coding unit. In one embodiment, if a pixel having a different motion vector exists in the target hierarchical sub-coding unit, the terminal device may determine non-translational inter prediction as the inter prediction mode corresponding to the target hierarchical sub-coding unit.

If the inter prediction direction corresponding to the target hierarchical sub-coding unit is the forward prediction, each pixel in the target hierarchical sub-coding unit may include a motion vector in a forward direction, in other words, each pixel may include one motion vector. In one embodiment, if the inter prediction direction corresponding to the target hierarchical sub-coding unit is the backward prediction, each pixel in the target hierarchical sub-coding unit may include a motion vector in a backward direction, in other words, each pixel may include one motion vector. In one embodiment, if the inter prediction direction corresponding to the target hierarchical sub-coding unit is the bidirectional prediction, each pixel in the target hierarchical sub-coding unit may include a motion vector in a forward direction and a motion vector in a backward direction, in other words, each pixel may include two motion vectors.

Therefore, if the inter prediction direction corresponding to the target hierarchical sub-coding unit is the forward prediction, motion vectors in the forward direction of all the pixels in the target hierarchical sub-coding unit are the same, indicating that motion vectors respectively corresponding to all the pixels in the target hierarchical sub-coding unit are the same. In one embodiment, if the inter prediction direction corresponding to the target hierarchical sub-coding unit is the backward prediction, motion vectors in the backward direction of all the pixels in the target hierarchical sub-coding unit are the same, indicating that motion vectors respectively corresponding to all the pixels in the target hierarchical sub-coding unit are the same. In one embodiment, if the inter prediction direction corresponding to the target hierarchical sub-coding unit is the bidirectional prediction, motion vectors in the backward direction of all the pixels in the target hierarchical sub-coding unit are the same and motion vectors in the forward direction of all the pixels in the target hierarchical sub-coding unit are the same, in other words, motion vectors in two directions of all the pixels in the target hierarchical sub-coding unit are the same, indicating that motion vectors respectively corresponding to all the pixels in the target hierarchical sub-coding unit are the same.

The terminal device may determine, based on inter prediction modes respectively corresponding to the P hierarchical sub-coding units and inter prediction directions respectively corresponding to the P hierarchical sub-coding units, whether coding results of the P hierarchical sub-coding units satisfy a motion similarity condition. For a process in which the coding results of the P hierarchical sub-coding units satisfy the motion similarity condition, refer to the following operation S204 and operation S205. In one embodiment, for a process in which the coding results of the P hierarchical sub-coding units do not satisfy the motion similarity condition, refer to the following operation S206 and operation S207.

Operation S204: Determine, if the inter prediction modes respectively corresponding to the P hierarchical sub-coding units are all translational inter prediction and the inter prediction directions respectively corresponding to the P hierarchical sub-coding units are all the same, that the coding results of the P hierarchical sub-coding units satisfy the motion similarity condition.

For example, if the inter prediction modes respectively corresponding to the P hierarchical sub-coding units are all the translational inter prediction, and the inter prediction directions respectively corresponding to the P hierarchical sub-coding units are all forward prediction, the terminal device may determine that the coding results of the P hierarchical sub-coding units satisfy the motion similarity condition.

Therefore, the motion similarity condition refers to a condition that the obtained inter prediction modes respectively corresponding to the P hierarchical sub-coding units are all the translational inter prediction, and the inter prediction directions respectively corresponding to the P hierarchical sub-coding units are all the same.

In one embodiment, if the inter prediction modes respectively corresponding to the P hierarchical sub-coding units are all the translational inter prediction, the terminal device may determine that the coding results of the P hierarchical sub-coding units satisfy the motion similarity condition. In one embodiment, if the inter prediction directions respectively corresponding to the P hierarchical sub-coding units are all the same, the terminal device may determine that the coding results of the P hierarchical sub-coding units satisfy the motion similarity condition.

Operation S205: Crop, based on the hierarchical sub-coding unit, a full reference frame set constructed for the to-be-coded unit, to generate a candidate reference frame set corresponding to the to-be-coded unit in a non-division form.

For a specific process in which the terminal device crops, based on the hierarchical sub-coding unit, the full reference frame set constructed for the to-be-coded unit, to generate the candidate reference frame set corresponding to the to-be-coded unit in the non-division form, refer to the foregoing descriptions of operation S103 in the embodiment corresponding to FIG. 3. Details are not described herein again.

In other words, if the coding result of the hierarchical sub-coding unit satisfies the motion similarity condition, the terminal device may crop, based on the hierarchical sub-coding unit, the full reference frame set constructed for the to-be-coded unit, to generate the candidate reference frame set corresponding to the to-be-coded unit in the non-division form,

Operation S206: Determine, if a hierarchical sub-coding unit of which an inter prediction mode is not translational inter prediction exists in the P hierarchical sub-coding units or the inter prediction directions respectively corresponding to the P hierarchical sub-coding units are different, that the coding results of the P hierarchical sub-coding units do not satisfy the motion similarity condition.

In one embodiment, if the hierarchical sub-coding unit of which the inter prediction mode is not translational inter prediction exists in the P hierarchical sub-coding units, the terminal device may determine that the coding results of the P hierarchical sub-coding units do not satisfy the motion similarity condition. In one embodiment, if the inter prediction directions respectively corresponding to the P hierarchical sub-coding units are different, the terminal device may determine that the coding results of the P hierarchical sub-coding units do not satisfy the motion similarity condition.

Operation S207: Obtain a full reference frame set constructed for the to-be-coded unit, and determine the full reference frame set as a candidate reference frame set corresponding to the to-be-coded unit in a non-division form.

For a specific process in which the terminal device obtains the full reference frame set constructed for the to-be-coded unit, refer to the foregoing descriptions of operation S103 in the embodiment corresponding to FIG. 3. Details are not described herein again.

In other words, if the coding result of the hierarchical sub-coding unit does not satisfy the motion similarity condition, the terminal device may obtain the full reference frame set constructed for the to-be-coded unit, and determine the full reference frame set as the candidate reference frame set corresponding to the to-be-coded unit in the non-division form.

The candidate reference frame set generated in operation S205 and operation

S207 may be configured for obtaining a target reference frame for the to-be-coded unit through traversal. The target reference frame may be configured for coding the to-be-coded unit, to generate a compressed bitstream corresponding to the to-be-coded unit.

The candidate reference frame set includes a forward candidate reference frame set and a backward candidate reference frame set. A specific process in which the terminal device obtains the target reference frame through traversal in the candidate reference frame set may be described as: The terminal device may determine a video frame type of the target video frame. The video frame type of the target video frame may be for indicating a video coder to select, from the candidate reference frame set, a reference frame configured for coding the target video frame. In this embodiment of this application, the reference frame obtained through traversal in the candidate reference frame set may be referred to as the target reference frame. Further, if the video frame type is a unidirectional prediction type (that is, a third type), the terminal device may obtain through traversal, in the forward candidate reference frame set or the backward candidate reference frame set, the target reference frame configured for coding the to-be-coded unit. In one embodiment, if the video frame type is a bidirectional prediction type (that is, a second type), the terminal device may obtain through traversal, in the forward candidate reference frame set, the backward candidate reference frame set, or a bidirectional reference frame set, the target reference frame configured for coding the to-be-coded unit. The bidirectional reference frame set includes the forward candidate reference frame set and the backward candidate reference frame set. In other words, if the video frame type is the bidirectional prediction type, the terminal device may obtain through traversal, in the forward candidate reference frame set or the backward candidate reference frame set, the target reference frame configured for coding the to-be-coded unit. Alternatively, the terminal device may obtain through traversal, in the forward candidate reference frame set and the backward candidate reference frame set, the target reference frame configured for coding the to-be-coded unit.

When an attempt is made to avoid dividing a coding unit CU (for example, the to-be-coded unit), the video coder needs to select an appropriate prediction mode for the to-be-coded unit. The prediction mode may include two types: inter prediction and intra prediction. The inter prediction may further be classified into translational inter prediction and affine inter prediction based on different motion forms. During the translational inter prediction, motion vectors of all pixels in the to-be-coded unit are the same. During the affine inter prediction, motion vectors of all pixels in the to-be-coded unit may be different. The affine inter prediction is applicable to a scaling and rotation motion. The non-translational inter prediction may include the affine inter prediction.

Operation S208: Obtain, from the optimal coding mode and the non-division form, a final coding mode corresponding to the to-be-coded unit.

Specifically, the terminal device may obtain a first rate-distortion parameter of the optimal coding mode and a second rate-distortion parameter of the non-division form. Further, if the first rate-distortion parameter is greater than or equal to the second rate-distortion parameter, the terminal device may determine the non-division form as the final coding mode corresponding to the to-be-coded unit. In one embodiment, if the first rate-distortion parameter is less than the second rate-distortion parameter, the terminal device may determine the optimal coding mode as the final coding mode corresponding to the to-be-coded unit.

In other words, the terminal device may obtain the first rate-distortion parameter of the optimal coding mode and the second rate-distortion parameter of the non-division form. Further, if the first rate-distortion parameter is greater than the second rate-distortion parameter, the terminal device may determine the non-division form as the final coding mode corresponding to the to-be-coded unit. In one embodiment, if the first rate-distortion parameter is less than the second rate-distortion parameter, the terminal device may determine the optimal coding mode as the final coding mode corresponding to the to-be-coded unit. In one embodiment, if the first rate-distortion parameter is equal to the second rate-distortion parameter, the terminal device may determine the optimal coding mode or the non-division form as the final coding mode corresponding to the to-be-coded unit.

The terminal device may determine a video frame in the candidate reference frame set as a reference video frame associated with the to-be-coded unit. The video coder does not determine how to specifically select a reference video frame for coding. A selection varies and a coding effect varies. To obtain an optimal coding effect, the video coder may code each possible reference frame combination, where a motion search and motion compensation with extremely high complexity are included, to obtain a reference frame combination having the optimal coding effect. The coding effect in this embodiment of this application may be understood as distortion. The coding effect may be measured by using a rate-distortion cost. A coding effect based on the rate-distortion cost may also be referred to as a rate-distortion performance. The rate-distortion performance may be measured by using a rate-distortion parameter (for example, the first rate-distortion parameter or the second rate-distortion parameter).

A basic idea of the inter prediction is selecting, by using a time-domain correlation of the video data, an area having most similar pixel distribution from one or two previously encoded frames to perform prediction on a current CU (that is, the to-be-coded unit), and then coding only position information (that is, a horizontal coordinate and a vertical coordinate of the similar area in the video frame) of the similar area and a pixel difference between the to-be-coded CU and the similar area. Generally, a smaller pixel difference indicates fewer bytes that need to be transmitted and higher coding efficiency. If the coder finally selects an area that is not most proper for prediction, a bitstream that satisfies a standard can also be generated, and only a coding effect is weakened. Searching for the most proper area is a process with very high calculation complexity, and the coder usually performs pixel-by-pixel comparison to implement the process. This process is also referred to as the motion search.

Therefore, in this embodiment of this application, a bottom-up coding architecture may be implemented recursively. In the coding architecture, a small block may be coded first, and then a large block may be coded. A key point here is that coding in a non-division form needs to be performed when coding in the division form cannot be continued, so that in an entire block division process, recursion is performed until a smallest sub-CU is obtained, and coding is performed upward successively until coding in the non-division form is performed. In this case, when an attempt is made to code a CU (that is, the to-be-coded unit) in the non-division form, if the CU can continue to be divided, coding in various division forms of the CU has been completed, and the video coder has an optimal coding result of the current CU when the CU continues to be divided. In this embodiment of this application, a coding result of each sub-CU in a current optimal coding division form is sequentially queried. If a current optimal coding result meets a requirement, a reference frame list used when the current CU is coded in the non-division is cropped.

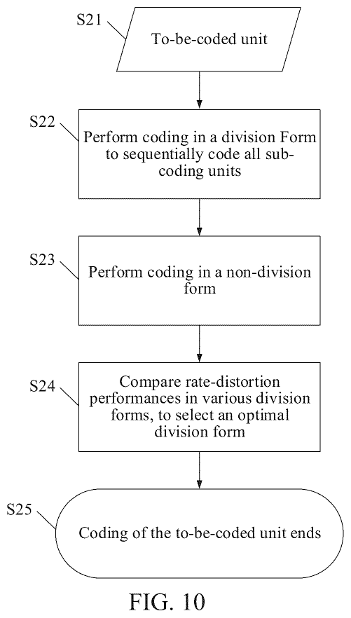

For ease of understanding, FIG. 10 is a schematic flowchart of coding a to-be-coded unit according to an embodiment of this application. As shown in FIG. 10, a terminal device may perform operation S21, to obtain a to-be-coded unit from a target video frame in operation S21. Further, the terminal device may perform operation S22 to perform coding in division in operation S22, so as to sequentially code all sub-coding units (in other words, division sub-coding units). to be specific, perform unit division on the to-be-coded unit, to obtain S unit division forms for the to-be-coded unit, and sequentially code all division sub-coding units in the S unit division forms, to generate hierarchical division forms respectively corresponding to the to-be-coded unit in the S unit division forms. For example, the S unit division forms may include a target unit division form, and the terminal device may sequentially code N division sub-coding units in the target unit division form, to generate hierarchical division forms corresponding to the to-be-coded unit in the target unit division form.

Further, as shown in FIG. 10, the terminal device may perform operation S23, to perform coding in non-division in operation S23. To be specific, the terminal device may generate, based on the S hierarchical division forms, a candidate reference frame set corresponding to the to-be-coded unit in the non-division form, and further code the to-be-coded unit based on the candidate reference frame set, to obtain a coding result of the to-be-coded unit in the non-division form.

Further, as shown in FIG. 10, the terminal device may perform operation S24, to compare rate-distortion performances in various division forms in operation S24, so as to select an optimal division form (that is, a final coding mode), to be specific, compare a rate-distortion performance of an optimal coding mode with a rate-distortion performance of the non-division form, to obtain, from the optimal coding mode and the non-division form, the final coding mode corresponding to the to-be-coded unit. Further, the terminal device may perform operation S25, and operation S25 indicates that coding of the to-be-coded unit ends.

In view of this, in this embodiment of this application, recursive hierarchical division may be performed on the to-be-coded unit in the target video frame, to obtain the S hierarchical division forms for the to-be-coded unit, so as to obtain a hierarchical sub-coding unit corresponding to the optimal coding mode in the S hierarchical division forms. The candidate reference frame set corresponding to the to-be-coded unit in the non-division form is determined based on an inter prediction mode corresponding to the hierarchical sub-coding unit and an inter prediction direction corresponding to the hierarchical sub-coding unit, to code the to-be-coded unit based on the candidate reference frame set. Therefore, the final coding mode corresponding to the to-be-coded unit may be obtained from the optimal coding mode and the non-division form. Therefore, when the target video frame is coded based on the final coding mode, a coding effect and coding efficiency of the target video frame can both be ensured.

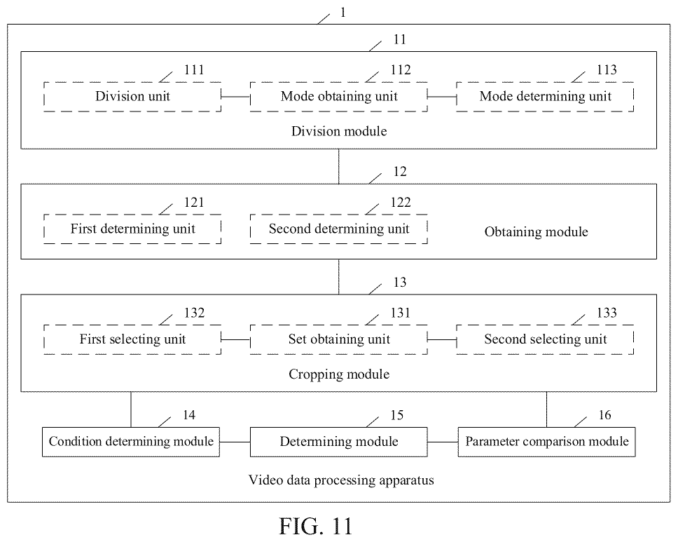

Further, FIG. 11 is a schematic diagram of a structure a video data processing apparatus according to an embodiment of this application. A video data processing apparatus 1 may include: a division module 11, an obtaining module 12, and a cropping module 13. Further, the video data processing apparatus 1 may include: a condition determining module 14, a determining module 15, and a parameter comparison module 16.

The division module 11 is configured to perform recursive hierarchical division on a to-be-coded unit in a target video frame, to obtain S hierarchical division forms for the to-be-coded unit. S is a positive integer, and the target video frame is a video frame in video data;

The division module 11 includes: a division unit 111, a mode obtaining unit 112, and a mode determining unit 113.

The division unit 111 is configured to perform unit division on the to-be-coded unit in the target video frame, to obtain S unit division forms for the to-be-coded unit. The S unit division forms include a target unit division form; the target unit division form includes N division sub-coding units of the to-be-coded unit; Nis an integer greater than 1; and the N division sub-coding units includes a target division sub-coding unit.

The mode obtaining unit 112 is configured to obtain a final sub-unit coding mode corresponding to the target division sub-coding unit.

The mode obtaining unit 112 is specifically configured to perform, if the target division sub-coding unit satisfies a unit division condition, recursive hierarchical division on the target division sub-coding unit, to obtain S sub-unit hierarchical division forms for the target division sub-coding unit.

The mode obtaining unit 112 is specifically configured to: obtain an optimal sub-unit coding mode for the target division sub-coding unit from the S sub-unit hierarchical division forms, and obtain a sub-unit hierarchical sub-coding unit corresponding to the optimal sub-unit coding mode.

The mode obtaining unit 112 is specifically configured to crop, based on the sub-unit hierarchical sub-coding unit, if a sub-unit coding result of the sub-unit hierarchical sub-coding unit satisfies the motion similarity condition, a sub-unit full reference frame set constructed for the target division sub-coding unit, to generate a sub-unit candidate reference frame set corresponding to the target division sub-coding unit in the non-division form. The sub-unit candidate reference frame set is configured for obtaining a sub-unit target reference frame for the target division sub-coding unit through traversal, and the sub-unit target reference frame is configured for coding the target division sub-coding unit.

The mode obtaining unit 112 is specifically configured to obtain, from the optimal sub-unit coding mode and the non-division form, the final sub-unit coding mode corresponding to the target division sub-coding unit.

The mode obtaining unit 112 is specifically configured to obtain a sub-unit size of the target division sub-coding unit.

The mode obtaining unit 112 is specifically configured to determine, if the sub-unit size is greater than or equal to a size threshold, that the target division sub-coding unit satisfies the unit division condition; or
the mode obtaining unit 112 is specifically configured to determine, if the sub-unit size is less than a size threshold, that the target division sub-coding unit does not satisfy the unit division condition.

The mode obtaining unit 112 is specifically configured to determine, if the target division sub-coding unit does not satisfy the unit division condition, the non-division form as the final sub-unit coding mode corresponding to the target division sub-coding unit.

The mode determining unit 113 is configured to determine final sub-unit coding modes respectively corresponding to the N division sub-coding units as hierarchical division forms corresponding to the to-be-coded unit in the target unit division form.

For specific implementations of the division unit 111, the mode obtaining unit 112, and the mode determining unit 113, refer to the foregoing descriptions of operation S1011 to operation S1013 in the embodiment corresponding to FIG. 7 and operation S101 in the embodiment corresponding to FIG. 3, and details are not described herein again.

The obtaining module 12 is configured to: obtain an optimal coding mode for the to-be-coded unit from the S hierarchical division forms, and obtain a hierarchical sub-coding unit corresponding to the optimal coding mode.

The optimal coding mode includes M division sub-coding units of the to-be-coded unit; M is an integer greater than 1; and the M division sub-coding units includes an auxiliary division sub-coding unit.

The obtaining module 12 includes: a first determining unit 121 and a second determining unit 122.

The first determining unit 121 is configured to determine, if the auxiliary division sub-coding unit has no sub-coding unit, the auxiliary division sub-coding unit as the hierarchical sub-coding unit corresponding to the optimal coding mode.

The second determining unit 122 is configured to obtain, if the auxiliary division sub-coding unit has sub-coding units, the hierarchical sub-coding unit corresponding to the optimal coding mode from the auxiliary division sub-coding unit.

For specific implementations of the first determining unit 121 and the second determining unit 122, refer to the foregoing descriptions of operation S102 in the embodiment corresponding to FIG. 3, and details are not described herein again.

The cropping module 13 is configured to: crop, based on the hierarchical sub-coding unit, if a coding result of the hierarchical sub-coding unit satisfies a motion similarity condition, a full reference frame set constructed for the to-be-coded unit, to generate a candidate reference frame set corresponding to the to-be-coded unit in a non-division form. The candidate reference frame set is configured for obtaining a target reference frame for the to-be-coded unit through traversal, and the target reference frame is configured for coding the to-be-coded unit.

The candidate reference frame set includes a forward candidate reference frame set and a backward candidate reference frame set. The full reference frame set includes a forward full reference frame set and a backward full reference frame set.

The cropping module 13 includes: a set obtaining unit 131, a first selecting unit 132, and a second selecting unit 133.

The set obtaining unit 131 is configured to obtain, from the video data, the forward full reference frame set and the backward full reference frame set that are constructed for the to-be-coded unit.

The set obtaining unit 131 is specifically configured to obtain, from the video data, a coded video frame coded before the target video frame.

The set obtaining unit 131 is specifically configured to add, if the coded video frame is played before the target video frame, the coded video frame played before the target video frame to the forward full reference frame set constructed for the to-be-coded unit; or
the set obtaining unit 131 is specifically configured to add, if the coded video frame is played after the target video frame, the coded video frame played after the target video frame to the backward full reference frame set constructed for the to-be-coded unit.

The first selecting unit 132 is configured to: select, in the forward full reference frame set, a reference frame used for the hierarchical sub-coding unit, and determine, if the reference frame used for the hierarchical sub-coding unit exists in the forward full reference frame set, the reference frame selected in the forward full reference frame set as the forward candidate reference frame set corresponding to the to-be-coded unit in the non-division form.

The second selecting unit 133 is configured to: select, in the backward full reference frame set, a reference frame used for the hierarchical sub-coding unit, and determine, if the reference frame used for the hierarchical sub-coding unit exists in the backward full reference frame set, the reference frame selected in the backward full reference frame set as the backward candidate reference frame set corresponding to the to-be-coded unit in the non-division form.

For specific implementations of the set obtaining unit 131, the first selecting unit 132, and the second selecting unit 133, refer to the foregoing descriptions of operation S103 in the embodiment corresponding to FIG. 3, and details are not described herein again.

In one embodiment, a quantity of hierarchical sub-coding units is P; P is an integer greater than 1; and the P hierarchical sub-coding units includes a target hierarchical sub-coding unit.

The condition determining module 14 is configured to obtain an inter prediction mode and an inter prediction direction corresponding to the target hierarchical sub-coding unit.

The condition determining module 14 is configured to determine, if inter prediction modes respectively corresponding to the P hierarchical sub-coding units are all translational inter prediction and inter prediction directions respectively corresponding to the P hierarchical sub-coding units are all the same, that coding results of the P hierarchical sub-coding units satisfy the motion similarity condition; or
the condition determining module 14 is configured to determine, if a hierarchical sub-coding unit of which an inter prediction mode is not translational inter prediction exists in the P hierarchical sub-coding units or inter prediction directions respectively corresponding to the P hierarchical sub-coding units are different, that coding results of the P hierarchical sub-coding units do not satisfy the motion similarity condition.

The condition determining module 14 is specifically configured to obtain the inter prediction direction corresponding to the target hierarchical sub-coding unit. The inter prediction direction corresponding to the target hierarchical sub-coding unit includes forward prediction, backward prediction, and bidirectional prediction.

The condition determining module 14 is specifically configured to obtain motion vectors corresponding to all pixels in the target hierarchical sub-coding unit.

The condition determining module 14 is specifically configured to determine, if the motion vectors corresponding to all the pixels in the target hierarchical sub-coding unit are the same, translational inter prediction as the inter prediction mode corresponding to the target hierarchical sub-coding unit; or
the condition determining module 14 is specifically configured to determine, if a pixel having a different motion vector exists in the target hierarchical sub-coding unit, non-translational inter prediction as the inter prediction mode corresponding to the target hierarchical sub-coding unit.

In one embodiment, the determining module 15 is configured to: obtain, if the coding result of the hierarchical sub-coding unit does not satisfy the motion similarity condition, the full reference frame set constructed for the to-be-coded unit, and determine the full reference frame set as the candidate reference frame set corresponding to the to-be-coded unit in the non-division form.

In one embodiment, the parameter comparison module 16 is configured to obtain a first rate-distortion parameter of the optimal coding mode and a second rate-distortion parameter of the non-division form.

The parameter comparison module 16 is configured to determine, if the first rate-distortion parameter is greater than or equal to the second rate-distortion parameter, the non-division form as a final coding mode corresponding to the to-be-coded unit; or
the parameter comparison module 16 is configured to determine, if the first rate-distortion parameter is less than the second rate-distortion parameter, the optimal coding mode as the final coding mode corresponding to the to-be-coded unit.

For specific implementations of the division module 11, the obtaining module 12, and the cropping module 13, refer to the foregoing descriptions of operation S101 to operation S103 in the embodiment corresponding to FIG. 3, and operation S1011 to operation S1013 in the embodiment corresponding to FIG. 7, and details are not described herein again. For specific implementations of the condition determining module 14, the determining module 15, and the parameter comparison module 16, refer to the foregoing descriptions of operation S201 to operation S208 in the embodiment corresponding to FIG. 9, and details are not described herein again. In addition, the descriptions of beneficial effects of the same method are not described herein again.

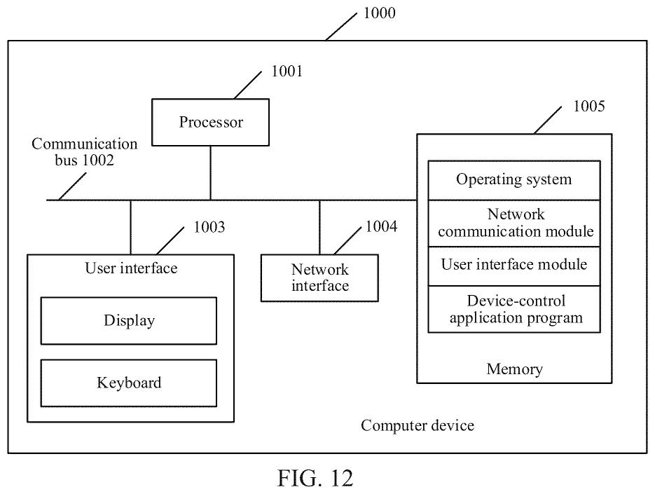

Further, FIG. 12 is a schematic diagram of a structure of a computer device according to an embodiment of this application. The computer device may be a terminal device or a server. As shown in FIG. 12, the computer device 1000 may include: a processor 1001, a network interface 1004, and a memory 1005. In addition, the computer device 1000 may further include: a user interface 1003 and at least one communication bus 1002. The communication bus 1002 is configured to implement connections and communication between the components. In some embodiments, the user interface 1003 may include a display and a keyboard. In one embodiment, the user interface 1003 may further include a standard wired interface and wireless interface. In one embodiment, the network interface 1004 may include a standard wired interface or wireless interface (such as a WI-FI interface). The memory 1005 may be a high-speed RAM memory, or may be a non-volatile memory, for example, at least one magnetic disk memory. In one embodiment, the memory 1005 may also be at least one storage apparatus that is located far away from the processor 1001. As shown in FIG. 12, the memory 1005 used as a computer storage medium may include an operating system, a network communications module, a user interface module, and a device-control application program.

In the computer device 1000 shown in FIG. 8, the network interface 1004 may provide a network communication function. The user interface 1003 is mainly configured to provide an input interface for a user. The processor 1001 may be configured to invoke the device-control application program stored in the memory 1005 to implement:
performing recursive hierarchical division on a to-be-coded unit in a target video frame, to obtain S hierarchical division forms for the to-be-coded unit, S being a positive integer, and the target video frame being a video frame in video data;
obtaining an optimal coding mode for the to-be-coded unit from the S hierarchical division forms, and obtaining a hierarchical sub-coding unit corresponding to the optimal coding mode; and
cropping, based on the hierarchical sub-coding unit, if a coding result of the hierarchical sub-coding unit satisfies a motion similarity condition, a full reference frame set constructed for the to-be-coded unit, to generate a candidate reference frame set corresponding to the to-be-coded unit in a non-division form. The candidate reference frame set is configured for obtaining a target reference frame for the to-be-coded unit through traversal, and the target reference frame is configured for coding the to-be-coded unit.

The computer device 1000 described in this embodiment of this application may implement the foregoing descriptions of the video data processing method in the embodiment corresponding to FIG. 3, FIG. 7 or FIG. 9, and may further implement the foregoing descriptions of the video data processing apparatus 1 in the embodiment corresponding to FIG. 11. Details are not described herein again. In addition, the descriptions of beneficial effects of the same method are not described herein again.

In addition, an embodiment of this application further provides a non-transitory computer-readable storage medium, and the computer-readable storage medium has a computer program that is executed by the video data processing apparatus 1 mentioned above and that is stored thereon. When the processor executes the computer program, the descriptions of the video data processing method in the embodiment corresponding to FIG. 3, FIG. 7 or FIG. 9 can be implemented. Therefore, details are not described herein again. In addition, the descriptions of beneficial effects of the same method are not described herein again. For technical details that are not disclosed in the computer-readable storage medium embodiments of this application, refer to the descriptions of the method embodiments of this application.

In addition, an embodiment of this application further provides a computer program product, the computer program product includes a computer program, and the computer program may be stored in a computer readable storage medium. A processor of a computer device reads the computer program from the computer readable storage medium, and the processor may execute the computer program, so that the computer device implements the foregoing descriptions of the video data processing method in the embodiment corresponding to FIG. 3, FIG. 7 or FIG. 9. Therefore, details are not described herein again. In addition, the descriptions of beneficial effects of the same method are not described herein again. For technical details not disclosed in the computer program product embodiments in this application, refer to the descriptions of the method embodiments of this application.

A person of ordinary skill in the art may understand that all or some of the processes of the methods in the embodiments may be implemented by a computer program instructing relevant hardware. The computer program may be stored in a computer-readable storage medium. When the program is executed, the procedures of the foregoing method embodiments are performed. The storage medium may be a magnetic disc, an optical disc, a read-only memory (ROM), a random access memory (RAM), or the like.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A video data processing method, comprising:
performing recursive hierarchical division on a target unit in a target video frame, to obtain S hierarchical division forms for the target unit, S being a positive integer;
obtaining an optimal coding mode for the target unit from the S hierarchical division forms and a hierarchical sub-coding unit corresponding to the optimal coding mode; and
cropping, based on the hierarchical sub-coding unit, a full reference frame set constructed for the target unit when a coding result of the hierarchical sub-coding unit satisfies a motion similarity condition, to generate a candidate reference frame set corresponding to the target unit in a non-division form, the candidate reference frame set being configured for obtaining a target reference frame for coding the target unit through traversal.

2. The method according to claim 1, wherein the performing recursive hierarchical division on a target unit in a target video frame, to obtain S hierarchical division forms for the target unit comprises:
performing unit division on the target unit in the target video frame, to obtain S unit division forms for the target unit, the S unit division forms comprising a target unit division form, the target unit division form comprising N division sub-coding units of the target unit, N being an integer greater than 1, and the N division sub-coding units comprising a target division sub-coding unit;
obtaining a final sub-unit coding mode corresponding to the target division sub-coding unit; and
determining final sub-unit coding modes respectively corresponding to the N division sub-coding units as hierarchical division forms corresponding to the target unit in the target unit division form.

3. The method according to claim 2, wherein the obtaining a final sub-unit coding mode corresponding to the target division sub-coding unit comprises:
performing recursive hierarchical division on the target division sub-coding unit to obtain S sub-unit hierarchical division forms for the target division sub-coding unit when the target division sub-coding unit satisfies a unit division condition;
obtaining, from the S sub-unit hierarchical division forms, an optimal sub-unit coding mode for the target division sub-coding unit, and obtaining a sub-unit hierarchical sub-coding unit corresponding to the optimal sub-unit coding mode;
cropping, based on the sub-unit hierarchical sub-coding unit, a sub-unit full reference frame set constructed for the target division sub-coding unit when a sub-unit coding result of the sub-unit hierarchical sub-coding unit satisfies the motion similarity condition, to generate a sub-unit candidate reference frame set corresponding to the target division sub-coding unit in the non-division form, the sub-unit candidate reference frame set being configured for obtaining a sub-unit target reference frame for the target division sub-coding unit through traversal, and the sub-unit target reference frame being configured for coding the target division sub-coding unit; and
obtaining, from the optimal sub-unit coding mode and the non-division form, the final sub-unit coding mode corresponding to the target division sub-coding unit.

4. The method according to claim 3, further comprising:
obtaining a sub-unit size of the target division sub-coding unit; and
determining, when the sub-unit size is greater than or equal to a size threshold, that the target division sub-coding unit satisfies the unit division condition; or
determining, when the sub-unit size is less than a size threshold, that the target division sub-coding unit does not satisfy the unit division condition.

5. The method according to claim 3, further comprising:
determining, when the target division sub-coding unit does not satisfy the unit division condition, the non-division form as the final sub-unit coding mode corresponding to the target division sub-coding unit.

6. The method according to claim 1, wherein the optimal coding mode comprises M division sub-coding units of the target unit; M is an integer greater than 1; and the M division sub-coding units comprise an auxiliary division sub-coding unit; and
the obtaining a hierarchical sub-coding unit corresponding to the optimal coding mode comprises:
determining, when the auxiliary division sub-coding unit has no sub-coding unit, the auxiliary division sub-coding unit as the hierarchical sub-coding unit corresponding to the optimal coding mode, or
obtaining, when the auxiliary division sub-coding unit has sub-coding units, the hierarchical sub-coding unit corresponding to the optimal coding mode from the auxiliary division sub-coding unit.

7. The method according to claim 1, wherein the candidate reference frame set comprises a forward candidate reference frame set and a backward candidate reference frame set; the full reference frame set comprises a forward full reference frame set and a backward full reference frame set; and
the cropping, based on the hierarchical sub-coding unit, a full reference frame set constructed for the target unit, to generate a candidate reference frame set corresponding to the target unit in a non-division form comprises:
obtaining, from video data, the forward full reference frame set and the backward full reference frame set that are constructed for the target unit;
selecting, in the forward full reference frame set, a reference frame used for the hierarchical sub-coding unit, and determining, when the reference frame used for the hierarchical sub-coding unit exists in the forward full reference frame set, the reference frame selected in the forward full reference frame set as the forward candidate reference frame set corresponding to the target unit in the non-division form; and
selecting, in the backward full reference frame set, a reference frame used for the hierarchical sub-coding unit, and determining, when the reference frame used for the hierarchical sub-coding unit exists in the backward full reference frame set, the reference frame selected in the backward full reference frame set as the backward candidate reference frame set corresponding to the target unit in the non-division form.

8. The method according to claim 7, wherein the obtaining, from the video data, the forward full reference frame set and the backward full reference frame set that are constructed for the target unit comprises:
obtaining, from the video data, a coded video frame coded before the target video frame; and
adding, when the coded video frame is played before the target video frame, the coded video frame played before the target video frame to the forward full reference frame set constructed for the target unit; and
adding, when the coded video frame is played after the target video frame, the coded video frame played after the target video frame to the backward full reference frame set constructed for the target unit.

9. The method according to claim 1, wherein a quantity of hierarchical sub-coding units is P; P is an integer greater than 1; and the P hierarchical sub-coding units comprise a target hierarchical sub-coding unit; and
the method further comprises:
obtaining an inter prediction mode and an inter prediction direction corresponding to the target hierarchical sub-coding unit; and
determining, when inter prediction modes respectively corresponding to the P hierarchical sub-coding units are all translational inter prediction and inter prediction directions respectively corresponding to the P hierarchical sub-coding units are all the same, that coding results of the P hierarchical sub-coding units satisfy the motion similarity condition; or
determining, when a hierarchical sub-coding unit of which an inter prediction mode is not translational inter prediction exists in the P hierarchical sub-coding units or inter prediction directions respectively corresponding to the P hierarchical sub-coding units are different, that coding results of the P hierarchical sub-coding units do not satisfy the motion similarity condition.

10. The method according to claim 9, wherein the obtaining an inter prediction mode and an inter prediction direction corresponding to the target hierarchical sub-coding unit comprises:
obtaining the inter prediction direction corresponding to the target hierarchical sub-coding unit, the inter prediction direction corresponding to the target hierarchical sub-coding unit comprising forward prediction, backward prediction, and bidirectional prediction;
obtaining motion vectors corresponding to all pixels in the target hierarchical sub-coding unit; and
determining, when the motion vectors corresponding to all the pixels in the target hierarchical sub-coding unit are the same, translational inter prediction as the inter prediction mode corresponding to the target hierarchical sub-coding unit; or
determining, when a pixel having a different motion vector exists in the target hierarchical sub-coding unit, non-translational inter prediction as the inter prediction mode corresponding to the target hierarchical sub-coding unit.

11. The method according to claim 1, further comprising:
obtaining, when the coding result of the hierarchical sub-coding unit does not satisfy the motion similarity condition, the full reference frame set constructed for the target unit, and determining the full reference frame set as the candidate reference frame set corresponding to the target unit in the non-division form.

12. The method according to claim 1, further comprising:
obtaining a first rate-distortion parameter of the optimal coding mode and a second rate-distortion parameter of the non-division form; and
determining, if the first rate-distortion parameter is greater than or equal to the second rate-distortion parameter, the non-division form as a final coding mode corresponding to the target unit; or
determining, if the first rate-distortion parameter is less than the second rate-distortion parameter, the optimal coding mode as a final coding mode corresponding to the target unit.

13. A computer device, comprising: a processor and a memory,
the processor and the memory being connected, the memory being configured to store a computer program, and the computer program, when executed by the processor, causing the computer device to perform a video data processing method including:
performing recursive hierarchical division on a target unit in a target video frame, to obtain S hierarchical division forms for the target unit, S being a positive integer;
obtaining an optimal coding mode for the target unit from the S hierarchical division forms and a hierarchical sub-coding unit corresponding to the optimal coding mode; and
cropping, based on the hierarchical sub-coding unit, a full reference frame set constructed for the target unit when a coding result of the hierarchical sub-coding unit satisfies a motion similarity condition, to generate a candidate reference frame set corresponding to the target unit in a non-division form, the candidate reference frame set being configured for obtaining a target reference frame for coding the target unit through traversal.

14. The computer device according to claim 13, wherein the performing recursive hierarchical division on a target unit in a target video frame, to obtain S hierarchical division forms for the target unit comprises:
performing unit division on the target unit in the target video frame, to obtain S unit division forms for the target unit, the S unit division forms comprising a target unit division form, the target unit division form comprising N division sub-coding units of the target unit, N being an integer greater than 1, and the N division sub-coding units comprising a target division sub-coding unit;
obtaining a final sub-unit coding mode corresponding to the target division sub-coding unit; and
determining final sub-unit coding modes respectively corresponding to the N division sub-coding units as hierarchical division forms corresponding to the target unit in the target unit division form.

15. The computer device according to claim 13, wherein the optimal coding mode comprises M division sub-coding units of the target unit; M is an integer greater than 1; and the M division sub-coding units comprise an auxiliary division sub-coding unit; and
the obtaining a hierarchical sub-coding unit corresponding to the optimal coding mode comprises:
determining, when the auxiliary division sub-coding unit has no sub-coding unit, the auxiliary division sub-coding unit as the hierarchical sub-coding unit corresponding to the optimal coding mode, or
obtaining, when the auxiliary division sub-coding unit has sub-coding units, the hierarchical sub-coding unit corresponding to the optimal coding mode from the auxiliary division sub-coding unit.

16. The computer device according to claim 13, wherein the candidate reference frame set comprises a forward candidate reference frame set and a backward candidate reference frame set; the full reference frame set comprises a forward full reference frame set and a backward full reference frame set; and
the cropping, based on the hierarchical sub-coding unit, a full reference frame set constructed for the target unit, to generate a candidate reference frame set corresponding to the target unit in a non-division form comprises:
obtaining, from the video data, the forward full reference frame set and the backward full reference frame set that are constructed for the target unit;
selecting, in the forward full reference frame set, a reference frame used for the hierarchical sub-coding unit, and determining, when the reference frame used for the hierarchical sub-coding unit exists in the forward full reference frame set, the reference frame selected in the forward full reference frame set as the forward candidate reference frame set corresponding to the target unit in the non-division form; and
selecting, in the backward full reference frame set, a reference frame used for the hierarchical sub-coding unit, and determining, when the reference frame used for the hierarchical sub-coding unit exists in the backward full reference frame set, the reference frame selected in the backward full reference frame set as the backward candidate reference frame set corresponding to the target unit in the non-division form.

17. The computer device according to claim 13, wherein a quantity of hierarchical sub-coding units is P; P is an integer greater than 1; and the P hierarchical sub-coding units comprise a target hierarchical sub-coding unit; and
the method further comprises:
obtaining an inter prediction mode and an inter prediction direction corresponding to the target hierarchical sub-coding unit; and
determining, when inter prediction modes respectively corresponding to the P hierarchical sub-coding units are all translational inter prediction and inter prediction directions respectively corresponding to the P hierarchical sub-coding units are all the same, that coding results of the P hierarchical sub-coding units satisfy the motion similarity condition; or
determining, when a hierarchical sub-coding unit of which an inter prediction mode is not translational inter prediction exists in the P hierarchical sub-coding units or inter prediction directions respectively corresponding to the P hierarchical sub-coding units are different, that coding results of the P hierarchical sub-coding units do not satisfy the motion similarity condition.

18. The computer device according to claim 13, wherein the method further comprises:
obtaining, when the coding result of the hierarchical sub-coding unit does not satisfy the motion similarity condition, the full reference frame set constructed for the target unit, and determining the full reference frame set as the candidate reference frame set corresponding to the target unit in the non-division form.

19. The computer device according to claim 13, wherein the method further comprises:
obtaining a first rate-distortion parameter of the optimal coding mode and a second rate-distortion parameter of the non-division form; and
determining, if the first rate-distortion parameter is greater than or equal to the second rate-distortion parameter, the non-division form as a final coding mode corresponding to the target unit; or
determining, if the first rate-distortion parameter is less than the second rate-distortion parameter, the optimal coding mode as a final coding mode corresponding to the target unit.

20. A non-transitory computer-readable storage medium, having a computer program stored thereon, the computer program, when executed by a processor of a computer device, causing the computer device to perform a video data processing method including:
performing recursive hierarchical division on a target unit in a target video frame, to obtain S hierarchical division forms for the target unit, S being a positive integer;
obtaining an optimal coding mode for the target unit from the S hierarchical division forms and a hierarchical sub-coding unit corresponding to the optimal coding mode; and
cropping, based on the hierarchical sub-coding unit, a full reference frame set constructed for the target unit when a coding result of the hierarchical sub-coding unit satisfies a motion similarity condition, to generate a candidate reference frame set corresponding to the target unit in a non-division form, the candidate reference frame set being configured for obtaining a target reference frame for coding the target unit through traversal.
